(19) United States
(12) Patent Application Publication
(10) Pub. No.: US 2026/0194731 A1
(43) Pub. Date: Jul. 9, 2026

(54) CAMERA OPTICAL LENS

(71) Applicant: Changzhou AAC Raytech Optronics Co., Ltd., Changzhou City (CN)

(72) Inventors: Congfang Si, Changzhou (CN); Shunda Zhou, Changzhou (CN)

(21) Appl. No.: 19/340,751

(22) Filed: Sep. 25, 2025

Related U.S. Application Data
(63) Continuation of application No. PCT/CN2025/070661, filed on Jan. 6, 2025.

(51) Int. Cl. G02B 9/62; G02B 13/00

(52) U.S. Cl. CPC G02B 9/62; G02B 13/0045

(57) ABSTRACT

A camera optical lens includes seven lenses sequentially from an object side to an image side: a first lens with positive refractive power, a second lens with negative refractive power, a third lens with negative refractive power, a fourth lens with positive refractive power, a fifth lens with negative refractive power, a sixth lens with positive refractive power, and a seventh lens with negative refractive power. Following relational expressions are satisfied: 1.10≤R9/R10≤1.90; 1.50≤(R5+R6)/(R5−R6)≤2.80; 17.00≤(f6−f7)/d12≤20.00; and 0.17≤(v1−v2)*d2/(f1−f2)≤0.32. The camera optical lens has good optical performance and characteristics of large aperture, wide-angle, and ultra-thinness, and is particularly suitable for a mobile phone camera lens assembly and a WEB camera lens composed of camera elements such as CCD, CMOS with high resolution.

### TECHNICAL FIELD

The present disclosure relates to the field of optical lenses, and in particular, to a camera optical lens suitable for handheld terminal devices such as smart phones, digital cameras, and camera devices such as monitors and PC lenses.

### BACKGROUND

In recent years, with the rise of various smart devices, the demand for a miniaturized camera optical lens has gradually increased. Since pixel size of the optical sensor is reduced, and the current electronic product has a development trend of light weight, thinness and being portable, the miniaturized camera optical lens with good imaging quality has become a mainstream of the current market. In order to obtain better imaging quality, a multi-lens structure is mostly used. In addition, with the development of technology and the increase of user's diversified requirements, under the condition that the pixel area of the optical sensor is continuously reduced and the requirements on the imaging quality of the system are continuously improved, a structure with seven lenses gradually appears in the lens design. There is an urgent need for a wide-angle camera lens with excellent optical performance, small size, and sufficiently corrected aberrations.

### SUMMARY

In view of the above problems, a main object of the present disclosure is to provide a camera optical lens, which has good optical performance and meets design requirements of large aperture, ultra-thinness and wide-angle.

In order to achieve the above object, the technical solution of the present disclosure provides a camera optical lens. The camera optical lens includes seven lenses sequentially from an object side to an image side: a first lens with positive refractive power, a second lens with negative refractive power, a third lens with negative refractive power, a fourth lens with positive refractive power, a fifth lens with negative refractive power, a sixth lens with positive refractive power, and a seventh lens with negative refractive power;
a central curvature radius of an object-side surface of the third lens is R5, a central curvature radius of an image-side surface of the third lens is R6, a central curvature radius of an object-side surface of the fifth lens is R9, a central curvature radius of an image-side surface of the fifth lens is R10, a focal length of the first lens is f1, a focal length of the second lens is f2, a focal length of the sixth lens is f6, a focal length of the seventh lens is f7, an on-axis distance from an image-side surface of the first lens to an object-side surface of the second lens is d2, an on-axis distance from an image-side surface of the sixth lens to an object-side surface of the seventh lens is d12, an Abbe number of the first lens is v1, an Abbe number of the second lens is v2, and following relational expressions are satisfied:

$$\begin{matrix}1.1 \leq R 9 / R 10 \leq 1.9 ; \\ 1.5 \leq ( R 5 + R 6 ) / ( R 5 - R 6 ) \leq 2 \text{.80} ; \\ 17. \leq ( f 6 - f 7 ) / d 12 \leq 20. ; and \\ 0.17 \leq ( v 1 - v 2 ) * d 2 / ( f 1 - f 2 ) \leq 0.32 .\end{matrix}$$

As an improvement, a central curvature radius of an object-side surface of the sixth lens is R11, a central curvature radius of the image-side surface of the sixth lens is R12, the focal length of the sixth lens is f6, and a following relational expression is satisfied:

$$1. 2 \leq ( R 11 + R 12 ) / f 6 \leq 2.05 .$$

As an improvement, a focal length of the camera optical lens is f, a combined focal length of the first lens, the second lens, the third lens, and the fourth lens is f1234, and a following relational expression is satisfied:

$$1. 25 \leq f 1234 / f \leq 1.4 .$$

As an improvement, an object-side surface of the first lens is convex in a paraxial region, and the image-side surface of the first lens is concave in the paraxial region;
a focal length of the camera optical lens is f, the focal length of the first lens is f1, a central curvature radius of the object-side surface of the first lens is R1, a central curvature radius of the image-side surface of the first lens is R2, an on-axis thickness of the first lens is d1, and a total optical length from the object-side surface of the first lens to an image plane of the camera optical lens along an optic axis of the camera optical lens is TTL, and following relational expressions are satisfied:

$$\begin{matrix}1.12 \leq f 1 / f \leq 1.18 ; \\ - 1.97 \leq ( R 1 + R 2 ) / ( R 1 - R 2 ) \leq - 1.93 ; and \\ 0.13 \leq d 1 / TTL \leq 0.14 .\end{matrix}$$

As an improvement, the object-side surface of the second lens is convex in a paraxial region, and an image-side surface of the second lens is concave in the paraxial region;
a focal length of the camera optical lens is f, a central curvature radius of the object-side surface of the second lens is R3, a curvature radius of the image-side surface of the second lens is R4, an on-axis thickness of the second lens is d3, a total optical length from the object-side surface of the first lens to an image plane of the camera optical lens along an optic axis of the camera optical lens is TTL, and following relational expressions are satisfied:

$$\begin{matrix}- 9.24 \leq f 2 / f \leq 5.96 ; \\ 7.14 \leq ( R 3 + R 4 ) / ( R 3 - R 4 ) \leq 10.82 ; and \\ 0.03 \leq d 3 / TTL \leq 0.04 .\end{matrix}$$

As an improvement, the object-side surface of the third lens is convex in a paraxial region, and the image-side surface of the third lens is concave in the paraxial region, and
a focal length of the camera optical lens is f, a focal length of the third lens is f3, an on-axis thickness of the third lens is d5, a total optical length from the object-side surface of the first lens to an image plane of the camera optical lens along an optic axis of the camera optical lens is TTL, and following relational expressions are satisfied:

$$\begin{matrix}- 4.41 \leq f 3 / f \leq - 3.07 ; and \\ 0.03 \leq d 5 / TTL \leq 0.04 .\end{matrix}$$

As an improvement, an object-side surface of the fourth lens is convex in a paraxial region, and an image-side surface of the fourth lens is convex in the paraxial region;
a focal length of the camera optical lens is f, a central curvature radius of the object-side surface of the fourth lens is R7, a central curvature radius of the image-side surface of the fourth lens is R8, and following relational expressions are satisfied:

$$3.39 \leq f 4 / f \leq 4.01 ; and$$

$$- 0.91 \leq ( R 7 + R 8 ) / ( R 7 - R 8 ) \leq - 0.59 .$$

As an improvement, an object-side surface of the fifth lens is convex in a paraxial region, and an image-side surface of the fifth lens is concave in the paraxial region;
a focal length of the camera optical lens is f, a focal length of the fifth lens is f5, and a following relational expression is satisfied:

$$- 50.60 \leq f 5 / f \leq - 7.82 ; and$$

$$3. 24 \leq ( R 9 + R 10 ) / ( R 9 - R 10 ) \leq 20.56 .$$

As an improvement, an object-side surface of the sixth lens is convex in a paraxial region, and the image-side surface of the sixth lens is concave in the paraxial region;
a focal length of the camera optical lens is f, a central curvature radius of the object-side surface of the sixth lens is R11, a central curvature radius of the image-side surface of the sixth lens is R12, an on-axis thickness of the fifth lens is d11, a total optical length from the object-side surface of the first lens to an image plane of the camera optical lens along an optic axis of the camera optical lens is TTL, and following relational expressions are satisfied:

$$1. 03 \leq f 6 / f \leq 1.21 ;$$

$$- 2.34 \leq ( R 11 + R 12 ) / ( R 11 - R 12 ) \leq - 1.68 ; and$$

$$0.06 \leq d 11 / TTL \leq 0.08 .$$

As an improvement, the object-side surface of the seventh lens is convex in a paraxial region, and an image-side surface of the seventh lens is concave in the paraxial region;
a focal length of the camera optical lens is f, a central curvature radius of the object-side surface of the seventh lens is R13, a central curvature radius of the image-side surface of the seventh lens is R14, and following relational expressions are satisfied:

$$- 0.89 \leq f 7 / f \leq - 0.86 ; and$$

$$1.99 \leq ( R 13 + R 14 ) / ( R 13 - R 14 ) \leq 2.07 .$$

As an improvement, the first lens is made of glass.

The present disclosure has following beneficial effects: the camera optical lens as described in the present disclosure has good optical performance and characteristics of large aperture, wide-angle, and ultra-thinness, and is particularly suitable for a mobile phone camera lens assembly and a WEB camera lens composed of camera elements such as CCD, CMOS with high resolution.

### BRIEF DESCRIPTION OF DRAWINGS

In order to more clearly illustrate technical solutions of embodiments of the present disclosure, the drawings to be used in the embodiments will be briefly described below. The drawings in the following description are some embodiments of the present disclosure. For those skilled in the art, other drawings may also be obtained based on these drawings. In which:

FIG. 1 is a structural schematic diagram of a camera optical lens according to Example 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Example 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Example 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Example 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a structural schematic diagram of a camera optical lens according to Example 5 of the present disclosure;

FIG. 18 is a schematic diagram of longitudinal aberration of the camera optical lens shown in FIG. 17;

FIG. 19 is a schematic diagram of lateral color of the camera optical lens shown in FIG. 17;

FIG. 20 is a schematic diagram of field curvature and distortion of the camera optical lens shown in FIG. 17;

FIG. 21 is a structural schematic diagram of a camera optical lens according to Comparative Example of the present disclosure;

FIG. 22 is a schematic diagram of longitudinal aberration of the camera optical lens shown in FIG. 21;

FIG. 23 is a schematic diagram of lateral color of the camera optical lens shown in FIG. 21; and

FIG. 24 is a schematic diagram of field curvature and distortion of the camera optical lens shown in FIG. 21.

### DESCRIPTION OF EMBODIMENTS

In order to more clearly illustrate objectives, technical solutions, and advantages of embodiments of the present disclosure, the following will provide a detailed description of various embodiments of the present disclosure in combination with the drawings. However, it should be understood by those skilled in the art that in each embodiment of the present disclosure, many technical details are presented to help readers better understand the present disclosure. However, even without these technical details and various changes and modifications based on the following embodiments, the technical solutions required to be protected by the present disclosure can still be achieved.

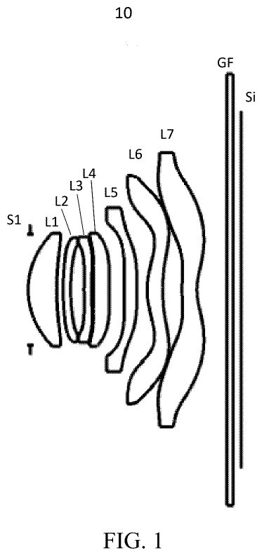

Referring to the drawings, the present disclosure provides camera optical lenses 10, 20, 30, 40 and 50. FIGS. 1, 5, 9, 13 and 17 show camera optical lenses 10, 20, 30, 40 and 50 according to Example 1 of the present disclosure. The camera optical lenses 10, 20, 30, 40 and 50 include seven lenses. The camera optical lens 10 sequentially includes from an object side to an image side: an aperture S1, a first lens L1, a second lens L2, a third lens L3, a fourth lens L4, a fifth lens L5, a sixth lens L6 and a seventh lens L7. An optical element such as an optical filter may be provided between the seventh lens L7 and an image surface Si.

The first lens L1 is made of plastic or glass material, the second lens L2 is made of plastic material, the third lens L3 is made of plastic material, the fourth lens L4 is made of plastic material, the fifth lens L5 is made of plastic material, the sixth lens L6 is made of plastic material, and the seventh lens L7 is made of plastic material. The lenses may also be made of other materials.

It is defined that a central curvature radius of an object-side surface of the fifth lens L5 is R9, a central curvature radius of an image-side surface of the fifth lens L5 is R10, 1.10≤R9/R10≤1.90, which specifies a shape of the fifth lens L5. Within the relational expression, a deflection degree of light passing through the lens can be reduced, thereby effectively reducing aberration.

It is defined that a central curvature radius of an object-side surface of the third lens L3 is R5, a central curvature radius of an image-side surface of the third lens L3 is R6, 1.50≤(R5+R6)/(R5−R6)≤2.80, which specifies a shape of the third lens L3, and is beneficial to correcting astigmatism and distortion of the camera lens, so that Distortion|<3%, and the possibility of vignetting generation is reduced.

It is defined that a focal length of the sixth lens L6 is f6, a focal length of the seventh lens L7 is f7, an on-axis distance from an image-side surface of the sixth lens L6 to an object-side surface of the seventh lens L7 is d12, 17.00≤(f6−f7)/d12≤20.00, while controlling the distance between the image side of the sixth lens L6 and the object side of the seventh lens L7 along the optic axis direction, the thickness of the structural part of the seventh lens L7 along the optic axis direction is also controlled. Moreover, this gap position may ensure a smooth transition at the edge of the effective diameter of the seventh lens L7, preventing problems such as bifurcation in the lens surface shape and avoiding adverse effects on the imaging effect. Meanwhile, by distributing the effective focal lengths of the two lenses, the number of light rays entering the structural part of the seventh lens L7 may be controlled. The thickness of the structural part may control the propagation direction and the number of reflections of light rays inside the lenses, thereby controlling stray light, reducing stray light imaging, and improving shooting quality.

It is defined that an Abbe number of the first lens L1 is v1, an Abbe number of the second lens L2 is v2, an on-axis distance from an image-side surface of the first lens L1 to an object-side surface of the second lens L2 is d2, a focal length of the first lens L1 is f1, a focal length of the second lens L2 is f2, 0.17≤(v1−v2)*d2/(f1−f2)≤0.32. Within the relational expression, the dimensional distribution of the structural parts of the first lens L1 and the second lens L2 along the optic axis direction is more reasonable. Under the condition that the lenses may be formed, the smaller the dimension of the lens structural parts along the optic axis direction, the fewer the stray light paths. Meanwhile, by controlling the dispersion coefficients of the first lens L1 and the second lens L2, the imaging quality of the lens group is improved. The smaller the ratio of (v1−v2)*d2/(f1−f2), the higher the imaging quality of the lens group.

It is defined that a central curvature radius of an object-side surface of the sixth lens L6 is R11, a central curvature radius of the image-side surface of the sixth lens L6 is R12, a focal length of the sixth lens L6 is f6, and a following relational expression is satisfied: 1.2≤(R11+R12)/f6≤2.05, and the relational expression may reasonably control the surface shape of the sixth lens L6, which helps reduce system sensitivity, while also reduce stray light generated by the lens, thereby improving imaging quality of the lens.

It is defined that a focal length of the camera optical lens 10 is f, a combined focal length of the first lens L1, the second lens L2, the third lens L3 and the fourth lens L4 is f1234, and a following relational expression is satisfied: 1.25≤f1234/f≤1.40. By reasonably distributing the optical focal length of the distribution system, the system has better imaging quality and lower sensitivity.

When the above relational expressions are satisfied, the camera optical lenses 10, 20, 30, 40 and 50 may have good optical performance, meet the design requirements of large aperture, wide-angle and ultra-thinness, and have the characteristics of low distortion and high imaging quality; according to the characteristics of the camera optical lenses 10, 20, 30, 40 and 50, the camera optical lenses 10, 20, 30, 40 and 50 are particularly suitable for mobile phone camera lens assemblies and WEB camera lenses composed of camera elements such as CCD and CMOS for high pixels.

Based on the above relational expressions and the achievable functions, the characteristics of each lens are further defined as follows.

An object-side surface of the first lens L1 is convex in a paraxial region, an image-side surface of the first lens L1 is concave in the paraxial region, and the first lens L1 has positive refractive power. The object-side surface and the image-side surface of the first lens L1 may also be provided with other concave and convex distributions.

A focal length of the camera optical lens is f, and the focal length of the first lens L1 is f1, and a following relational expression is satisfied: 1.125≤f1/f≤1.18, which specifies a ratio of the positive refractive power of the first lens L1 to the overall focal length. Within the relational expression, the first lens has a proper positive refractive power, which is beneficial to reducing system aberration, while it is beneficial to development of the lens assembly to ultra-thinness and wide-angle.

It is defined that a central curvature radius of an object-side surface of the first lens L1 is R1, a central curvature radius of the image-side surface of the first lens L1 is R2, and a following relational expression is satisfied: −1.97≤(R1+R2)/(R1−R2)≤−1.93. By reasonably controlling a shape of the first lens L1, the first lens L1 may effectively correct the spheric aberration of the system.

An on-axis thickness of the first lens L1 is d1, a total optical length from the object-side surface of the first lens to an image plane of the camera optical lens along an optic axis of the camera optical lens 10 is TTL, and following relational expression is satisfied: 0.13≤d1/TTL≤0.14, within the range of the relational expression, it is beneficial to achieving ultra-thinness.

The object-side surface of the second lens L2 is convex in the paraxial region, an image-side surface of the second lens L2 is concave in the paraxial region, and the second lens L2 has negative refractive power. The object-side surface and the image-side surface of the second lens L2 may be provided with other concave and convex distributions.

A focal length of the second lens L2 is f2, and following relational expression is satisfied: −9.24≤f2/f≤−5.96. By controlling the positive refractive power of the second lens L2 within a reasonable range, it is beneficial to correct the aberration of the optical system.

A central curvature radius of the object-side surface of the second lens L2 is R3, and a central curvature radius of the image-side surface of the second lens L2 is R4, a following relational expression is satisfied: 7.14≤(R3+R4)/(R3−R4)≤10.82, which specifies a shape of the second lens L2. Within the above range, as lenses develop towards ultra-thinness and wide-angle, it is beneficial to correct the problem of axial chromatic aberration.

An on-axis thickness of the second lens L2 is d3, the total optical length from the object-side surface of the first lens to an image plane of the camera optical lens along an optic axis of the camera optical lens 10 is TTL, and a following relational expression is satisfied: 0.03≤d3/TTL≤0.04, within the range of the relational expression, it is beneficial to achieve ultra-thinness.

An object-side surface of the third lens L3 is convex in a paraxial region, an image-side surface of the third lens L3 is concave in the paraxial region, and the third lens L3 has negative refractive power. The object-side surface and the image-side surface of the third lens L3 may also be provided with other concave and convex distributions.

A focal length of the third lens L3 is f3, and following relational expression is satisfied: −4.41≤f3/f≤−3.07, by reasonable distributing refractive powers, the system has better imaging quality and lower sensitivity.

An on-axis thickness of the third lens L3 is d5, the total optical length from the object-side surface of the first lens to an image plane of the camera optical lens along an optic axis of the camera optical lens 10 is TTL, and a following relational expression is satisfied: 0.03≤d5/TTL≤0.04, within the range of the relational expression, it is beneficial to achieve ultra-thinness.

An object-side surface of the fourth lens L4 is convex in a paraxial region, an image-side surface of the fourth lens L4 is concave in a paraxial region, and the fourth lens L4 has positive refractive power. The object-side surface and the image-side surface of the fourth lens L4 may also be provided with other concave and convex distributions.

A focal length of the fourth lens L4 is f4, and following relational expression is satisfied: 3.39≤f4/f≤4.01. By reasonably distributing refractive powers, the system has better imaging quality and lower sensitivity.

A central curvature radius of the object-side surface of the fourth lens L4 is R7, a central curvature radius of the image-side surface of the fourth lens L4 is R8, and following relational expression is satisfied: −0.91≤(R7+R8)/(R7−R8)≤−0.59, which specifies a shape of the fourth lens L4. Within the above range, as lenses develop towards ultra-thinness and wide-angle, it is beneficial to correct the problem of aberration of off-axis aberration.

An object-side surface of the fifth lens L5 is convex in a paraxial region, an image-side surface of the fifth lens L5 is concave in the paraxial region, and the fifth lens L5 has negative refractive power. The object-side surface and the image-side surface of the fifth lens L5 may also be provided with other concave and convex distributions.

A focal length of the fifth lens L5 is f5, and following relational expression is satisfied: −50.60≤f5/f≤−7.82. By reasonably distributing refractive powers, the system has better imaging quality and lower sensitivity.

A central curvature radius of the object-side surface of the fifth lens L5 is R9, a central curvature radius of the image-side surface of the fifth lens L5 is R10, and a following relational expression is satisfied: 3.24≤(R9+R10)/(R9−R10)≤20.56, which specifies a shape of the fifth lens L5. Within the above range, as lenses develop towards ultra-thinness and wide-angle, it is beneficial to correct the problem of aberration of off-axis aberration.

An object-side surface of the sixth lens L6 is convex in a paraxial region, the image-side surface of the sixth lens L6 is concave in the paraxial region, and the sixth lens L6 has positive refractive power. The object-side surface and the image-side surface of the sixth lens L6 may also be provided with other concave and convex distributions.

A focal length of the sixth lens L6 is f6, and a following relational expression is satisfied: 1.03≤f6/f≤1.21. By reasonably distributing refractive powers, the system has better imaging quality and lower sensitivity.

A central curvature radius of the object-side surface of the sixth lens L6 is R11, a central curvature radius of the image-side surface of the sixth lens L6 is R12, and a following relational expression is satisfied: −2.34≤(R11+R12)/≤−1.68, which specifies a shape of the sixth lens L6. Within the relational expression, it is beneficial to correct the problems such as the aberration of off-axis angles with the development of the ultra-thinness wide-angle.

An on-axis thickness of the sixth lens L6 is d11, a following relational expression is satisfied: 0.06≤d11/TTL≤0.08, within the range of the relational expression, it is beneficial to achieve ultra-thinness.

The object-side surface of the seventh lens L7 is convex in a paraxial region, an image-side surface of the seventh lens L7 is concave in the paraxial region, and the seventh lens L7 has negative refractive power. The object-side surface and the image-side surface of the seventh lens L7 may also be provided with other concave and convex distributions.

A focal length of the seventh lens L7 is f7, and a following relational expression is satisfied: −0.89≤f7/f≤−0.86. By reasonably distributing refractive powers, the system has better imaging quality and lower sensitivity.

A central curvature radius of the object-side surface of the seventh lens L7 is R13, a central curvature radius of the image-side surface of the seventh lens L7 is R14, and a following relational expression is satisfied: 1.99≤(R13+R14)/≤2.07, which specifies a shape of the seventh lens L7, within the range of the relational expression, as lenses develop towards ultra-thinness and wide-angle, it is beneficial to correct the problem of aberration of off-axis aberration.

The camera optical lens of the present disclosure will be described below with examples. The reference signs recited in each example are shown below. The units of the focal length, the on-axis distance, the central curvature radius, the on-axis thickness, the inflection point position, and the stationary point position are mm.

TTL: a total optical length from the object-side surface of the first lens to an image plane of the camera optical lens along an optic axis of the camera optical lens (the on-axis distance from the object-side surface of the first lens L1 to the image plane Si), in mm.

F-number FNO: a ratio of the effective focal length of the camera optical lens to the entrance pupil diameter.

Image height IH at 1.0 field of view: a field of view height corresponding to the sensor effective pixel (that is, half of a diagonal length of the sensor effective pixel area);
Field of view FOV at 1.0 field of view: a field of view corresponding to the active pixel of the sensor;
Image height IHm at MIC (Microscope Infrared Spectroscopy) field of view: a height of the field of view expanding beyond 1.0 field of view for preventing assembly deviation.

Field of view FOVm at MIC field of view: a field of view corresponding to an image height at MIC field of view.

Optionally, the object-side surface and/or the image-side surface of the lens may be further provided with an inflection point and/or an arrest point, so as to meet high-quality imaging requirements.

The technical solutions of the present disclosure will be described in five Examples. Meanwhile, a Comparative Example is provided as a reference, and the technical effects of the present disclosure cannot be achieved when the ranges of the above relational expressions are exceeded.

### Example 1

Table 1 shows design data of the camera optical lens 10 according to Example 1 of the present disclosure.

TABLE 1

| | R | d | | nd | | νd | |
|---|---|---|---|---|---|---|---|
| S1 | ∞ | d0= | −0.090 | | | | |
| R1 | 3.467 | d1= | 1.356 | nd1 | 1.4959 | ν1 | 81.64 |
| R2 | 10.796 | d2= | 0.306 | | | | |
| R3 | 10.351 | d3= | 0.358 | nd2 | 1.6700 | ν2 | 19.39 |
| R4 | 8.236 | d4= | 0.640 | | | | |
| R5 | 40.094 | d5= | 0.358 | nd3 | 1.6700 | ν3 | 19.39 |
| R6 | 13.622 | d6= | 0.073 | | | | |
| R7 | 18.464 | d7= | 0.779 | nd4 | 1.5444 | ν4 | 55.82 |
| R8 | −193.446 | d8= | 0.698 | | | | |
| R9 | 30.163 | d9= | 0.591 | nd5 | 1.5661 | ν5 | 37.71 |
| R10 | 20.146 | d10= | 0.504 | | | | |
| R11 | 3.592 | d11= | 0.742 | nd6 | 1.5444 | ν6 | 55.82 |
| R12 | 11.287 | d12= | 0.915 | | | | |
| R13 | 7.333 | d13= | 0.710 | nd7 | 1.5346 | ν7 | 55.69 |
| R14 | 2.494 | d14= | 1.420 | | | | |
| R15 | ∞ | d15= | 0.310 | ndg | 1.5168 | νg | 64.17 |
| R16 | ∞ | d16= | 0.390 | | | | |

The meaning of each reference sign is as follows:
S1: aperture;
R: central curvature radius of an optical surface;
R1: central curvature radius of the object-side surface of the first lens L1;
R2: central curvature radius of the image-side surface of the first lens L1;
R3: central curvature radius of the object-side surface of the second lens L2;
R4: central curvature radius of the image-side surface of the second lens L2;
R5: central curvature radius of the object-side surface of the third lens L3;
R6: central curvature radius of the image-side surface of the third lens L3;
R7: central curvature radius of the object-side surface of the fourth lens L4;
R8: central curvature radius of the image-side surface of the fourth lens L4;
R9: central curvature radius of the object-side surface of the fifth lens L5;
R10: central curvature radius of the image-side surface of the fifth lens L5;
R11: central curvature radius of the object-side surface of the sixth lens L6;
R12: central curvature radius of the image-side surface of the sixth lens L6;
R13: central curvature radius of the object-side surface of the seventh lens L7;
R14: central curvature radius of the image-side surface of the seventh lens L7;
R15: curvature radius of the object-side surface of the optical filter GF;
R16: curvature radius of the image-side surface of the optical filter GF;
d: on-axis thickness of lenses and an on-axis distance between lenses;
d0: on-axis distance from the aperture S1 to the object-side surface of the first lens L1;
d1: on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the sixth lens L6;
d11: on-axis thickness of the sixth lens L6;
d12: on-axis distance from the image-side surface of the sixth lens L6 to the object-side surface of the seventh lens L7;
d13: on-axis thickness of the seventh lens L7;
d14: on-axis distance from the image-side surface of the seventh lens L7 to the object-side surface of the eighth lens L8;
d15: on-axis thickness of the optical filter GF;
d16: on-axis distance from the image-side surface of the optical filter GF to the image surface Si;
nd: refractive index of d line;
nd1: refractive index of d line of the first lens L1;
nd2: refractive index of d line of the second lens L2;
nd3: refractive index of d line of the third lens L3;
nd4: refractive index of d line of the fourth lens L4;
nd5: a refractive index of d line of the fifth lens L5;
nd6: refractive index of d line of the sixth lens L6;
nd7: refractive index of d line of the seventh lens L7;
ndg: refractive index of d line of the optical filter GF;
vd: Abbe number;
v1: Abbe number of the first lens L1;
v2: Abbe number of the second lens L2;
v3: Abbe number of the third lens L3;
v4: Abbe number of the fourth lens L4;
v5: Abbe number of the fifth lens L5;
v6: Abbe number of the sixth lens L6;
v7: Abbe number of the seventh lens L7; and
vg: Abbe number of the optical filter GF.

Table 2 and Table 3 show the aspheric surface data of the lenses in the camera optical lens 10 according to Example 1 of the present disclosure.

TABLE 2

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −1.4442E−03 | −7.8270E−04 | 1.2302E−03 | −1.3851E−03 | 8.8543E−04 | −2.6428E−04 | −2.5313E−05 |
| R2 | 3.1941E+00 | −2.4065E−03 | −1.0249E−03 | −2.1314E−03 | 5.6330E−03 | −5.6975E−03 | 3.3476E−03 |
| R3 | −1.8196E−02 | −8.6323E−03 | 1.5439E−02 | −3.1109E−02 | 3.5087E−02 | −2.2212E−02 | 7.1765E−03 |
| R4 | 1.0007E−02 | −5.1405E−03 | 8.9958E−03 | −2.0781E−02 | 3.8153E−02 | −5.6670E−02 | 6.4552E−02 |
| R5 | −2.4049E+00 | −6.5622E−03 | −2.3539E−02 | 1.0718E−01 | −2.5725E−01 | 3.7637E−01 | −3.6722E−01 |
| R6 | 5.4699E−02 | −3.3903E−03 | −3.3143E−02 | 1.0374E−01 | −1.8475E−01 | 2.0591E−01 | −1.5454E−01 |
| R7 | −9.7309E−02 | −5.3594E−03 | −2.5204E−02 | 6.3817E−02 | −9.7642E−02 | 9.5376E−02 | −6.2765E−02 |
| R8 | −3.1944E+01 | −7.7730E−03 | −1.1676E−02 | 2.5242E−02 | −3.3925E−02 | 3.0036E−02 | −1.8547E−02 |
| R9 | −2.7412E+01 | −1.7688E−02 | 4.4673E−03 | −4.6040E−04 | 9.8236E−04 | −1.8651E−03 | 1.4120E−03 |
| R10 | −1.3324E−01 | −3.6289E−02 | 1.4943E−03 | 7.1837E−03 | −5.3525E−03 | 2.2049E−03 | −5.9976E−04 |
| R11 | −9.9685E−01 | −4.1795E−03 | −9.8123E−03 | 5.5018E−03 | −2.0907E−03 | 5.5844E−04 | −1.0615E−04 |
| R12 | 2.5503E−01 | 2.5135E−02 | −1.2480E−02 | 3.4002E−03 | −6.9662E−04 | 1.1209E−04 | −1.4482E−05 |
| R13 | −1.2103E+00 | −4.5561E−02 | 6.9531E−03 | −7.0086E−04 | 5.8671E−05 | −3.5415E−06 | 6.7579E−08 |
| R14 | −1.0123E+00 | −5.8248E−02 | 1.3183E−02 | −2.5922E−03 | 4.0649E−04 | −4.8661E−05 | 4.3512E−06 |

TABLE 3

| | Aspheric Coefficient | | | | | | | |
|---|---|---|---|---|---|---|---|---|
| | A16 | A18 | A20 | A22 | A24 | A26 | A28 | A30 |
| R1 | 5.0794E−05 | −1.9345E−05 | 3.8939E−06 | −4.5227E−07 | 2.8652E−08 | −7.6861E−10 | 0.0000E+00 | 0.0000E+00 |
| R2 | −1.2648E−03 | 3.1754E−04 | −5.2810E−05 | 5.5988E−06 | −3.4300E−07 | 9.2477E−09 | 0.0000E+00 | 0.0000E+00 |
| R3 | −8.6262E−05 | −9.4486E−04 | 4.2289E−04 | −9.6890E−05 | 1.2918E−05 | −9.5318E−07 | 3.0227E−08 | 0.0000E+00 |
| R4 | −5.3070E−02 | 3.0848E−02 | −1.2616E−02 | 3.6011E−03 | −7.0208E−04 | 8.9101E−05 | −6.6351E−06 | 2.2001E−07 |
| R5 | 2.4978E−01 | −1.2109E−01 | 4.2115E−02 | −1.0433E−02 | 1.7967E−03 | −2.0439E−04 | 1.3806E−05 | −4.1918E−07 |
| R6 | 8.1317E−02 | −3.0618E−02 | 8.2988E−03 | −1.6070E−03 | 2.1695E−04 | −1.9405E−05 | 1.0338E−06 | −2.4844E−08 |
| R7 | 2.8798E−02 | −9.3657E−03 | 2.1642E−03 | −3.5129E−04 | 3.8913E−05 | −2.7797E−06 | 1.1429E−07 | −2.0290E−09 |
| R8 | 8.2410E−03 | −2.6703E−03 | 6.3138E−04 | −1.0766E−04 | 1.2878E−05 | −1.0240E−06 | 4.8553E−08 | −1.0377E−09 |
| R9 | −6.1998E−04 | 1.7785E−04 | −3.4839E−05 | 4.7096E−06 | −4.3291E−07 | 2.5850E−08 | −9.0417E−10 | 1.4052E−11 |
| R10 | 1.1236E−04 | −1.4610E−05 | 1.3070E−06 | −7.8319E−08 | 2.9597E−09 | −6.0979E−11 | 3.8283E−13 | 4.5292E−15 |
| R11 | 1.4396E−05 | −1.3961E−06 | 9.6769E−08 | −4.7536E−09 | 1.6163E−10 | −3.6192E−12 | 4.8022E−14 | −2.8616E−16 |
| R12 | 1.4942E−06 | −1.2001E−07 | 7.2777E−09 | −3.2300E−10 | 1.0105E−11 | −2.1023E−13 | 2.6050E−15 | −1.4523E−17 |
| R13 | 9.3154E−09 | −9.4939E−10 | 4.4233E−11 | −1.2180E−12 | 2.0317E−14 | −1.9070E−16 | 7.7597E−19 | 0.0000E+00 |
| R14 | −2.8816E−07 | 1.4075E−08 | −5.0373E−10 | 1.3022E−11 | −2.3637E−13 | 2.8552E−15 | −2.0596E−17 | 6.7085E−20 |

For convenience, the aspheric surface of each lens surface uses the aspheric surface shown in following formula (1). However, the present disclosure is not limited to the aspheric polynomial form shown in formula (1).

$$y = ( {x}^{2} / R ) / [ 1 + {\{ 1 - ( k + 1 ) ( {x}^{2} / {R}^{2} ) \}}^{1 / 2} ] + A 4 {x}^{4} + A 6 {x}^{6} + A 8 {x}^{8} + A 10 {x}^{10} + A 12 {x}^{12} + A 14 {x}^{14} + A 16 {x}^{16} + A 18 {x}^{18} + A 20 {x}^{20} + A 22 {x}^{22} + A 24 {x}^{24} + A 26 {x}^{26} + A 28 {x}^{28} + A 30 {x}^{30} \qquad ( 1 )$$

k is a conic coefficient, A4, A6, A8, A10, A12, A14, A16, A18, A20, A22, A24, A26, A28 and A30 are aspheric coefficients, c is a curvature at a center of an optical surface, r is a vertical distance between a point on an aspheric curve and an optic axis, and z is an aspheric depth (a vertical distance between a point on the aspherical surface having a distance r from the optical axis, and a tangent plane tangent to a vertex on the aspherical optical axis).

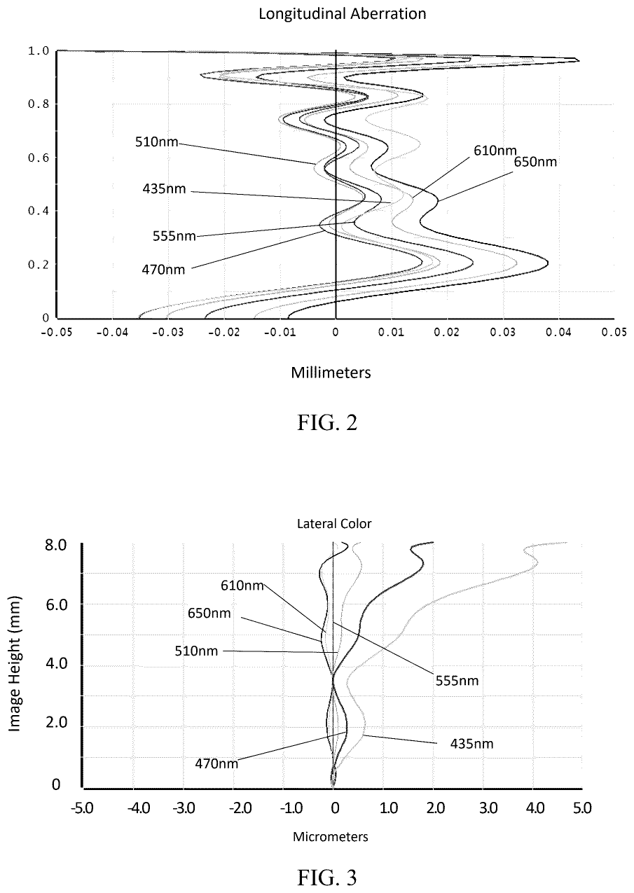

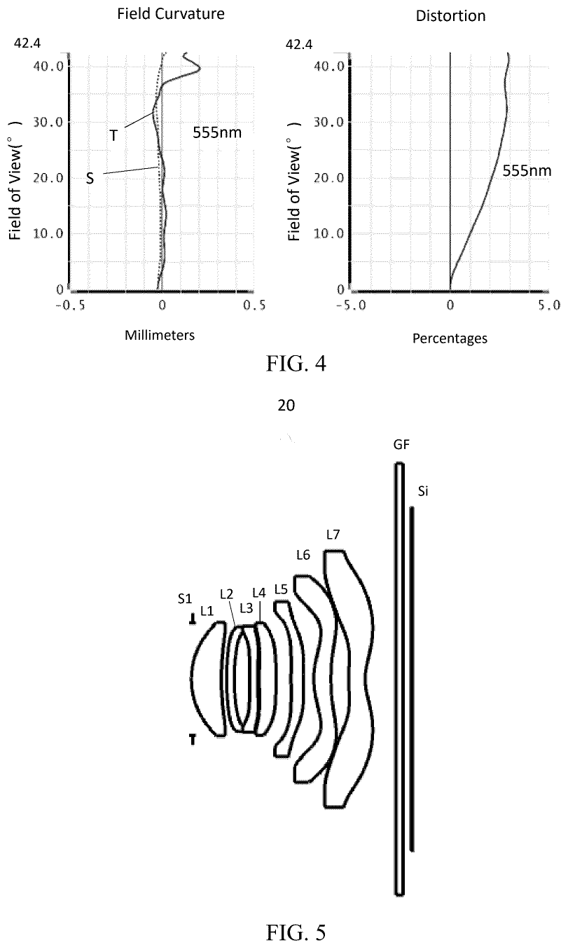

FIG. 2 and FIG. 3 respectively show longitudinal aberration and lateral color of light with wavelengths of 650 nm, 610 nm, 555 nm, 510 nm, 470 nm, and 435 nm after passing through the camera optical lens 10 according to Example 1. FIG. 4 shows field curvature and distortion of light with a wavelength of 555 nm after passing through the camera optical lens 10 according to Example 1, the field curvature S in FIG. 4 is a field curvature in a sagittal direction, and T is a field curvature in a meridian direction.

In this Example, the entrance pupil diameter ENPD of the camera optical lens 10 is 5.136 mm, the image height IH at 1.0 field of view is 8.000 mm, the field of view FOV at 1.0 field of view is 84.88°, the image height IHm at MIC field of view is 8.17 mm, and the field of view FOVm at MIC field of view is 86.52°. The camera optical lens 10 meets the design requirements of large aperture, wide-angle and ultra-thinness, effectively correcting both the on-axis and off-axis chromatic aberrations thereof, and has excellent optical characteristics.

### Example 2

Example 2 is substantially the same as Example 1, and the reference signs have the same meaning as Example 1, and only differences are listed below.

FIG. 5 shows a camera optical lens 20 according to Example 2 of the present disclosure.

Table 4 shows design data of a camera optical lens 20 according to Example 2 of the present disclosure.

TABLE 4

| | R | d | | nd | | νd | |
|---|---|---|---|---|---|---|---|
| S1 | INF | d0= | −0.053 | | | | |
| R1 | 3.439 | d1= | 1.382 | nd1 | 1.4959 | ν1 | 81.64 |
| R2 | 10.548 | d2= | 0.243 | | | | |
| R3 | 9.966 | d3= | 0.350 | nd2 | 1.6700 | ν2 | 19.39 |
| R4 | 8.279 | d4= | 0.711 | | | | |
| R5 | 70.445 | d5= | 0.378 | nd3 | 1.6700 | ν3 | 19.39 |
| R6 | 14.178 | d6= | 0.068 | | | | |
| R7 | 19.747 | d7= | 0.769 | nd4 | 1.5444 | ν4 | 55.82 |
| R8 | −79.262 | d8= | 0.701 | | | | |
| R9 | 33.433 | d9= | 0.573 | nd5 | 1.5661 | ν5 | 37.71 |
| R10 | 17.688 | d10= | 0.479 | | | | |
| R11 | 3.699 | d11= | 0.793 | nd6 | 1.5444 | ν6 | 55.82 |
| R12 | 14.427 | d12= | 0.818 | | | | |
| R13 | 7.102 | d13= | 0.760 | nd7 | 1.5346 | ν7 | 55.69 |
| R14 | 2.459 | d14= | 1.431 | | | | |
| R15 | INF | d15= | 0.310 | ndg | 1.5168 | νg | 64.17 |
| R16 | INF | d16= | 0.427 | | | | |

Table 5 and Table 6 show aspheric surface data of each lens in the camera optical lens 20 according to Example 2 of the present disclosure.

TABLE 5

| | Conic Coefficient | Aspheric Coefficient | | | | | |
|---|---|---|---|---|---|---|---|
| | k | A4 | A6 | A8 | A10 | A12 | A14 |
| R1 | 9.8904E−03 | −6.6011E−04 | 1.2498E−03 | −1.3846E−03 | 8.8534E−04 | −2.6430E−04 | −2.5313E−05 |
| R2 | 2.8099E+00 | −2.3963E−03 | −1.0211E−03 | −2.1303E−03 | 5.6330E−03 | −5.6976E−03 | 3.3476E−03 |
| R3 | 4.2939E−01 | −8.6157E−03 | 1.5415E−02 | −3.1117E−02 | 3.5087E−02 | −2.2212E−02 | 7.1765E−03 |
| R4 | 9.7528E−01 | −5.1924E−03 | 9.0124E−03 | −2.0777E−02 | 3.8152E−02 | −5.6670E−02 | 6.4552E−02 |
| R5 | −2.7744E+02 | −6.6260E−03 | −2.3552E−02 | 1.0718E−01 | −2.5725E−01 | 3.7637E−01 | −3.6722E−01 |
| R6 | −5.0452E+00 | −3.4768E−03 | −3.3151E−02 | 1.0374E−01 | −1.8475E−01 | 2.0591E−01 | −1.5454E−01 |
| R7 | −2.8132E+00 | −5.6188E−03 | −2.5231E−02 | 6.3820E−02 | −9.7641E−02 | 9.5376E−02 | −6.2764E−02 |
| R8 | 5.0782E+02 | −7.9001E−03 | −1.1643E−02 | 2.5250E−02 | −3.3925E−02 | 3.0036E−02 | −1.8547E−02 |
| R9 | 2.4835E+01 | −1.7274E−02 | 4.4477E−03 | −4.6058E−04 | 9.8252E−04 | −1.8650E−03 | 1.4120E−03 |
| R10 | −2.9754E+00 | −3.6443E−02 | 1.5006E−03 | 7.1839E−03 | −5.3525E−03 | 2.2049E−03 | −5.9976E−04 |
| R11 | −1.0400E+00 | −4.2736E−03 | −9.8141E−03 | 5.5017E−03 | −2.0907E−03 | 5.5844E−04 | −1.0615E−04 |
| R12 | 4.5505E−02 | 2.5473E−02 | −1.2474E−02 | 3.4000E−03 | −6.9663E−04 | 1.1209E−04 | −1.4482E−05 |
| R13 | −1.2177E+00 | −4.5598E−02 | 6.9526E−03 | −7.0085E−04 | 5.8671E−05 | −3.5415E−06 | 6.7579E−08 |
| R14 | −1.0179E+00 | −5.8200E−02 | 1.3185E−02 | −2.5922E−03 | 4.0649E−04 | −4.8661E−05 | 4.3512E−06 |

TABLE 6

| | Aspheric Coefficient | | | | | | | |
|---|---|---|---|---|---|---|---|---|
| | A16 | A18 | A20 | A22 | A24 | A26 | A28 | A30 |
| R1 | 5.0795E−05 | −1.9345E−05 | 3.8939E−06 | −4.5227E−07 | 2.8651E−08 | −7.6876E−10 | 0.0000E+00 | 0.0000E+00 |
| R2 | −1.2648E−03 | 3.1754E−04 | −5.2810E−05 | 5.5988E−06 | −3.4300E−07 | 9.2479E−09 | 0.0000E+00 | 0.0000E+00 |
| R3 | −8.6262E−05 | −9.4486E−04 | 4.2289E−04 | −9.6890E−05 | 1.2918E−05 | −9.5318E−07 | 3.0227E−08 | 1.2344E−14 |
| R4 | −5.3070E−02 | 3.0848E−02 | −1.2616E−02 | 3.6011E−03 | −7.0208E−04 | 8.9101E−05 | −6.6351E−06 | 2.2001E−07 |
| R5 | 2.4978E−01 | −1.2109E−01 | 4.2115E−02 | −1.0433E−02 | 1.7967E−03 | −2.0439E−04 | 1.3806E−05 | −4.1918E−07 |
| R6 | 8.1317E−02 | −3.0618E−02 | 8.2988E−03 | −1.6070E−03 | 2.1695E−04 | −1.9405E−05 | 1.0338E−06 | −2.4844E−08 |
| R7 | 2.8798E−02 | −9.3657E−03 | 2.1642E−03 | −3.5129E−04 | 3.8913E−05 | −2.7797E−06 | 1.1429E−07 | −2.0290E−09 |
| R8 | 8.2410E−03 | −2.6703E−03 | 6.3138E−04 | −1.0766E−04 | 1.2878E−05 | −1.0240E−06 | 4.8553E−08 | −1.0377E−09 |
| R9 | −6.1998E−04 | 1.7785E−04 | −3.4839E−05 | 4.7096E−06 | −4.3291E−07 | 2.5850E−08 | −9.0417E−10 | 1.4052E−11 |
| R10 | 1.1236E−04 | −1.4610E−05 | 1.3070E−06 | −7.8319E−08 | 2.9597E−09 | −6.0979E−11 | 3.8283E−13 | 4.5293E−15 |
| R11 | 1.4396E−05 | −1.3961E−06 | 9.6770E−08 | −4.7536E−09 | 1.6163E−10 | −3.6192E−12 | 4.8022E−14 | −2.8616E−16 |
| R12 | 1.4942E−06 | −1.2001E−07 | 7.2777E−09 | −3.2300E−10 | 1.0105E−11 | −2.1023E−13 | 2.6050E−15 | −1.4523E−17 |
| R13 | 9.3154E−09 | −9.4939E−10 | 4.4233E−11 | −1.2180E−12 | 2.0317E−14 | −1.9070E−16 | 7.7597E−19 | −2.0849E−28 |
| R14 | −2.8816E−07 | 1.4075E−08 | −5.0373E−10 | 1.3022E−11 | −2.3637E−13 | 2.8552E−15 | −2.0596E−17 | 6.7085E−20 |

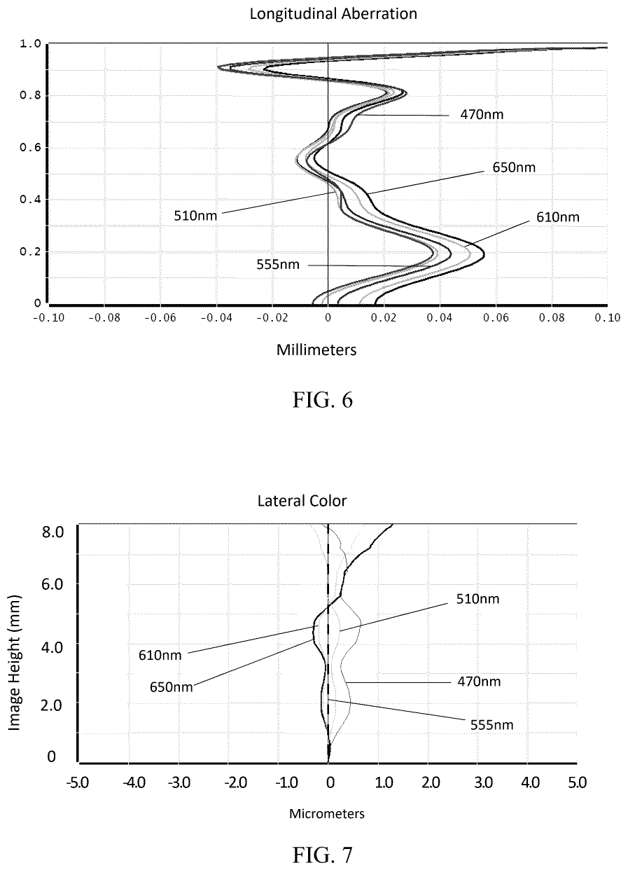

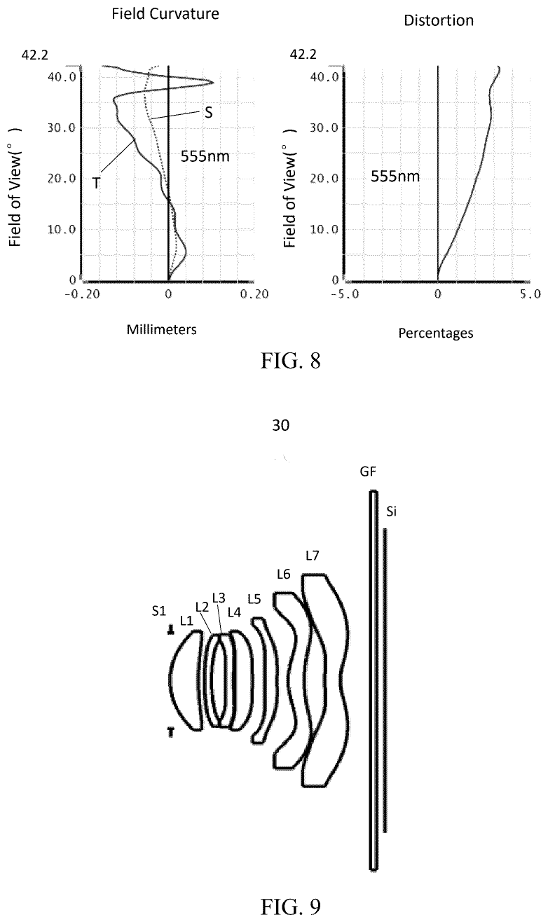

FIG. 6 and FIG. 7 show longitudinal aberration and lateral color of light with wavelengths of 650 nm, 610 nm, 555 nm, 510 nm and 470 nm after passing the camera optical lens 20 according to Example 2. FIG. 8 shows field curvature and distortion of light with a wavelength of 555 nm after passing through the camera optical lens 20 according to Example 2, the field curvature S in FIG. 8 is a field curvature in a sagittal direction, and T is a field curvature in a meridian direction.

In this Example, the entrance pupil diameter ENPD of the camera optical lens 20 is 5.181 mm, the image height IH at 1.0 field of view is 8.003 mm, the field of view FOV at 1.0 field of view is 84.38°, the image height IHm at MIC field of view is 8.177 mm, and the field of view FOVm at MIC field of view is 85.77°. The camera optical lens 20 meets the design requirements of large aperture, wide-angle and ultra-thinness, effectively correcting both the on-axis and off-axis chromatic aberrations thereof, and has excellent optical characteristics.

### Example 3

Example 3 is substantially the same as Example 1, the reference signs have the same meaning as Example 1, and only differences are listed below.

FIG. 9 shows a camera optical lens 30 according to Example 3 of the present disclosure.

Table 7 shows design data of the camera optical lens 30 according to Example 3 of the present disclosure.

TABLE 7

| | R | d | | nd | | νd | |
|---|---|---|---|---|---|---|---|
| S1 | INF | d0= | −0.029 | | | | |
| R1 | 3.513 | d1= | 1.335 | nd1 | 1.4959 | ν1 | 81.64 |
| R2 | 11.066 | d2= | 0.282 | | | | |
| R3 | 9.716 | d3= | 0.333 | nd2 | 1.6700 | ν2 | 19.39 |
| R4 | 7.829 | d4= | 0.668 | | | | |
| R5 | 52.901 | d5= | 0.373 | nd3 | 1.6700 | ν3 | 19.39 |
| R6 | 13.582 | d6= | 0.069 | | | | |
| R7 | 19.112 | d7= | 0.818 | nd4 | 1.5444 | ν4 | 55.82 |
| R8 | −371.097 | d8= | 0.600 | | | | |
| R9 | 22.017 | d9= | 0.569 | nd5 | 1.5661 | ν5 | 37.71 |
| R10 | 19.974 | d10= | 0.520 | | | | |
| R11 | 3.460 | d11= | 0.774 | nd6 | 1.5444 | ν6 | 55.82 |
| R12 | 10.647 | d12= | 0.962 | | | | |
| R13 | 7.112 | d13= | 0.728 | nd7 | 1.5346 | ν7 | 55.69 |
| R14 | 2.456 | d14= | 1.413 | | | | |
| R15 | INF | d15= | 0.310 | ndg | 1.5168 | νg | 64.17 |
| R16 | INF | d16= | 0.386 | | | | |

Table 8 and Table 9 show aspheric surface data of each lens in the camera optical lens 30 according to Example 3 of the present disclosure.

TABLE 8

| | Conic Coefficient | Aspheric Coefficient | | | | | |
|---|---|---|---|---|---|---|---|
| | k | A4 | A6 | A8 | A10 | A12 | A14 |
| R1 | 2.5529E−02 | −7.8008E−04 | 1.2301E−03 | −1.3861E−03 | 8.8510E−04 | −2.6431E−04 | −2.5308E−05 |
| R2 | 3.1310E+00 | −2.4057E−03 | −1.0343E−03 | −2.1313E−03 | 5.6331E−03 | −5.6976E−03 | 3.3476E−03 |
| R3 | 2.6547E−01 | −8.6066E−03 | 1.5453E−02 | −3.1110E−02 | 3.5087E−02 | −2.2213E−02 | 7.1765E−03 |
| R4 | 2.1453E−01 | −4.8853E−03 | 8.9865E−03 | −2.0777E−02 | 3.8154E−02 | −5.6670E−02 | 6.4552E−02 |
| R5 | −1.5452E+01 | −6.7558E−03 | −2.3556E−02 | 1.0718E−01 | −2.5725E−01 | 3.7637E−01 | −3.6722E−01 |
| R6 | −1.0292E−01 | −3.4336E−03 | −3.3158E−02 | 1.0374E−01 | −1.8475E−01 | 2.0591E−01 | −1.5454E−01 |
| R7 | 1.0670E+00 | −5.2992E−03 | −2.5212E−02 | 6.3815E−02 | −9.7642E−02 | 9.5375E−02 | −6.2765E−02 |
| R8 | 1.7843E+04 | −8.4118E−03 | −1.1722E−02 | 2.5237E−02 | −3.3926E−02 | 3.0036E−02 | −1.8547E−02 |
| R9 | −2.9252E+01 | −1.7480E−02 | 4.4523E−03 | −4.6154E−04 | 9.8238E−04 | −1.8651E−03 | 1.4120E−03 |
| R10 | −2.7210E+00 | −3.6249E−02 | 1.4988E−03 | 7.1836E−03 | −5.3526E−03 | 2.2049E−03 | −5.9976E−04 |
| R11 | −1.0391E+00 | −4.2107E−03 | −9.8164E−03 | 5.5018E−03 | −2.0907E−03 | 5.5844E−04 | −1.0615E−04 |
| R12 | −1.9941E−01 | 2.5171E−02 | −1.2482E−02 | 3.4002E−03 | −6.9661E−04 | 1.1209E−04 | −1.4482E−05 |
| R13 | −1.2412E+00 | −4.5550E−02 | 6.9544E−03 | −7.0084E−04 | 5.8672E−05 | −3.5415E−06 | 6.7579E−08 |
| R14 | −1.0054E+00 | −5.8240E−02 | 1.3185E−02 | −2.5922E−03 | 4.0649E−04 | −4.8661E−05 | 4.3512E−06 |

TABLE 9

| | Aspheric Coefficient | | | | | | | |
|---|---|---|---|---|---|---|---|---|
| | A16 | A18 | A20 | A22 | A24 | A26 | A28 | A30 |
| R1 | 5.0796E−05 | −1.9345E−05 | 3.8939E−06 | −4.5227E−07 | 2.8651E−08 | −7.6886E−10 | 0.0000E+00 | 0.0000E+00 |
| R2 | −1.2648E−03 | 3.1754E−04 | −5.2810E−05 | 5.5988E−06 | −3.4300E−07 | 9.2479E−09 | 0.0000E+00 | 0.0000E+00 |
| R3 | −8.6264E−05 | −9.4486E−04 | 4.2289E−04 | −9.6890E−05 | 1.2918E−05 | −9.5318E−07 | 3.0226E−08 | −2.2170E−14 |
| R4 | −5.3070E−02 | 3.0848E−02 | −1.2616E−02 | 3.6011E−03 | −7.0208E−04 | 8.9101E−05 | −6.6351E−06 | 2.2001E−07 |
| R5 | 2.4978E−01 | −1.2109E−01 | 4.2115E−02 | −1.0433E−02 | 1.7967E−03 | −2.0439E−04 | 1.3806E−05 | −4.1918E−07 |
| R6 | 8.1317E−02 | −3.0618E−02 | 8.2988E−03 | −1.6070E−03 | 2.1695E−04 | −1.9405E−05 | 1.0338E−06 | −2.4844E−08 |
| R7 | 2.8798E−02 | −9.3657E−03 | 2.1642E−03 | −3.5129E−04 | 3.8913E−05 | −2.7797E−06 | 1.1429E−07 | −2.0290E−09 |
| R8 | 8.2410E−03 | −2.6703E−03 | 6.3138E−04 | −1.0766E−04 | 1.2878E−05 | −1.0240E−06 | 4.8553E−08 | −1.0377E−09 |
| R9 | −6.1998E−04 | 1.7785E−04 | −3.4839E−05 | 4.7096E−06 | −4.3291E−07 | 2.5850E−08 | −9.0417E−10 | 1.4052E−11 |
| R10 | 1.1236E−04 | −1.4610E−05 | 1.3070E−06 | −7.8319E−08 | 2.9597E−09 | −6.0979E−11 | 3.8283E−13 | 4.5298E−15 |
| R11 | 1.4396E−05 | −1.3961E−06 | 9.6769E−08 | −4.7536E−09 | 1.6163E−10 | −3.6192E−12 | 4.8022E−14 | −2.8616E−16 |
| R12 | 1.4942E−06 | −1.2001E−07 | 7.2777E−09 | −3.2300E−10 | 1.0105E−11 | −2.1023E−13 | 2.6050E−15 | −1.4523E−17 |
| R13 | 9.3155E−09 | −9.4939E−10 | 4.4233E−11 | −1.2180E−12 | 2.0317E−14 | −1.9070E−16 | 7.7598E−19 | −3.6495E−26 |
| R14 | −2.8816E−07 | 1.4075E−08 | −5.0373E−10 | 1.3022E−11 | −2.3637E−13 | 2.8552E−15 | −2.0596E−17 | 6.7085E−20 |

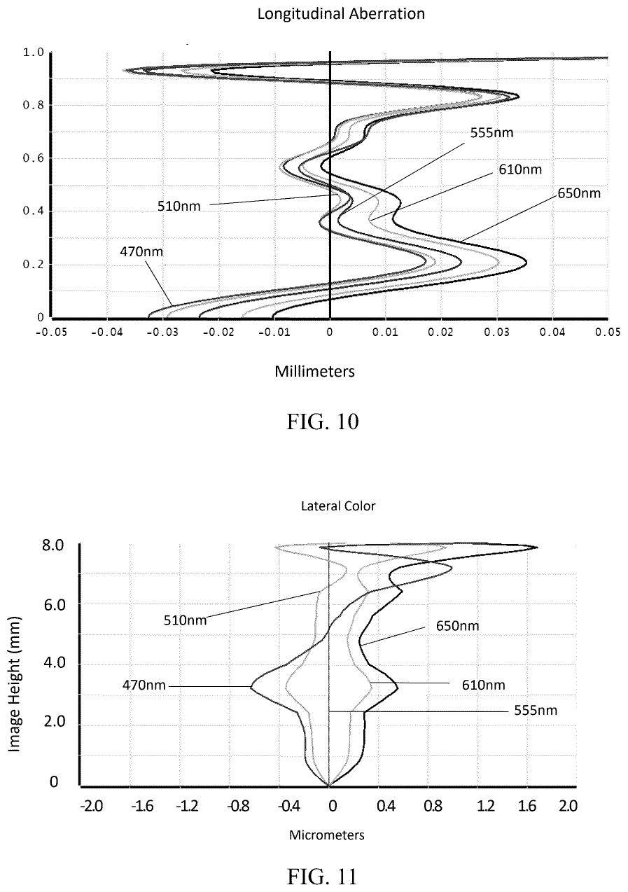

FIG. 10 and FIG. 11 show longitudinal aberration and lateral color of light with wavelengths of 650 nm, 610 nm, 555 nm, 510 nm and 470 nm after passing through the camera optical lens 30 according to Example 3. FIG. 12 shows field curvature and distortion of light with a wavelength of 555 nm after passing through the camera optical lens 30 according to Example 3, the field curvature S in FIG. 12 is a field curvature in a sagittal direction, and T is a field curvature in a meridian direction.

In this Example, the entrance pupil diameter ENPD of the camera optical lens 30 is 5.043 mm, the image height IH at 1.0 field of view is 8.000 mm, the field of view FOV at 1.0 field of view is 85.82°, the image height IHm at MIC field of view is 8.200 mm, and the field of view FOVm at MIC field of view is 87.24°. The camera optical lens 30 meets the design requirements of large aperture, wide-angle and ultra-thinness, effectively correcting both the on-axis and off-axis chromatic aberrations thereof, and has excellent optical characteristics.

### Example 4

Example 4 is substantially the same as Example 1, and the reference signs have the same meaning as Example 1, and only differences are listed below.

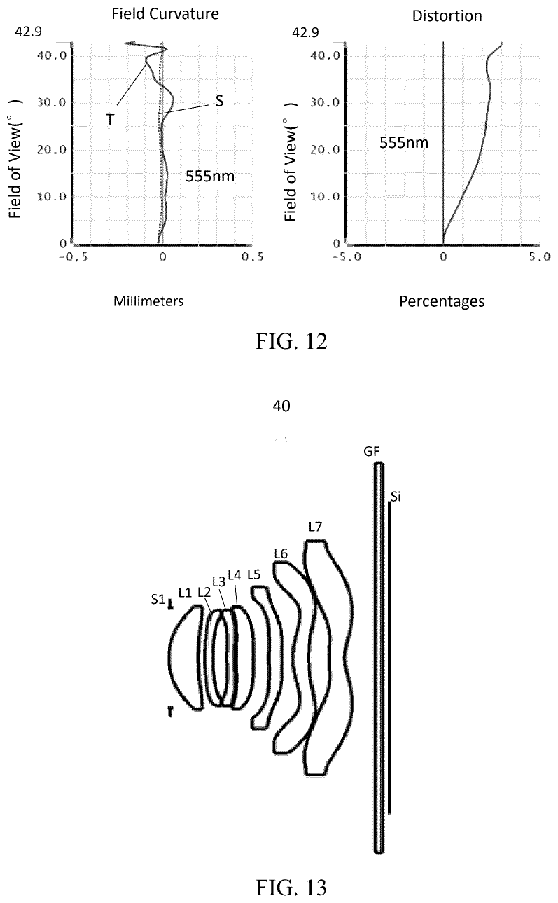

FIG. 13 shows a camera optical lens 40 according to Example 4 of the present disclosure.

Table 10 shows design data of the camera optical lens 40 according to Example 4 of the present disclosure.

TABLE 10

| | R | d | | nd | | νd | |
|---|---|---|---|---|---|---|---|
| S1 | INF | d0= | −0.072 | | | | |
| R1 | 3.443 | d1= | 1.352 | nd1 | 1.4959 | ν1 | 81.64 |
| R2 | 10.653 | d2= | 0.307 | | | | |
| R3 | 10.532 | d3= | 0.351 | nd2 | 1.6700 | ν2 | 19.39 |
| R4 | 7.946 | d4= | 0.653 | | | | |
| R5 | 27.850 | d5= | 0.351 | nd3 | 1.6700 | ν3 | 19.39 |
| R6 | 13.187 | d6= | 0.082 | | | | |
| R7 | 19.006 | d7= | 0.787 | nd4 | 1.5444 | ν4 | 55.82 |
| R8 | −168.136 | d8= | 0.717 | | | | |
| R9 | 28.910 | d9= | 0.593 | nd5 | 1.5661 | ν5 | 37.71 |
| R10 | 18.557 | d10= | 0.488 | | | | |
| R11 | 3.611 | d11= | 0.749 | nd6 | 1.5444 | ν6 | 55.82 |
| R12 | 11.233 | d12= | 0.925 | | | | |
| R13 | 7.455 | d13= | 0.723 | nd7 | 1.5346 | ν7 | 55.69 |
| R14 | 2.484 | d14= | 1.417 | | | | |
| R15 | INF | d15= | 0.310 | ndg | 1.5168 | νg | 64.17 |
| R16 | INF | d16= | 0.339 | | | | |

Table 11 and Table 12 show aspheric surface data of each lens in the camera optical lens 40 according to Example 4 of the present disclosure.

TABLE 11

| | Conic Coefficient | Aspheric Coefficient | | | | | |
|---|---|---|---|---|---|---|---|
| | k | A4 | A6 | A8 | A10 | A12 | A14 |
| R1 | 6.6276E−03 | −7.3056E−04 | 1.2339E−03 | −1.3847E−03 | 8.8545E−04 | −2.6427E−04 | −2.5312E−05 |
| R2 | 2.9096E+00 | −2.3612E−03 | −1.0238E−03 | −2.1321E−03 | 5.6328E−03 | −5.6976E−03 | 3.3476E−03 |
| R3 | −4.6812E−01 | −8.7223E−03 | 1.5429E−02 | −3.1112E−02 | 3.5087E−02 | −2.2213E−02 | 7.1765E−03 |
| R4 | −1.1446E−01 | −5.0718E−03 | 9.0196E−03 | −2.0775E−02 | 3.8154E−02 | −5.6670E−02 | 6.4552E−02 |
| R5 | 4.1815E+00 | −6.4793E−03 | −2.3529E−02 | 1.0718E−01 | −2.5725E−01 | 3.7637E−01 | −3.6722E−01 |
| R6 | −1.2640E−01 | −3.4664E−03 | −3.3157E−02 | 1.0374E−01 | −1.8475E−01 | 2.0591E−01 | −1.5454E−01 |
| R7 | −6.5601E+00 | −5.2861E−03 | −2.5201E−02 | 6.3817E−02 | −9.7642E−02 | 9.5376E−02 | −6.2765E−02 |
| R8 | 3.1052E+03 | −7.8411E−03 | −1.1706E−02 | 2.5242E−02 | −3.3925E−02 | 3.0036E−02 | −1.8547E−02 |
| R9 | −6.2047E+01 | −1.7673E−02 | 4.4801E−03 | −4.6041E−04 | 9.8239E−04 | −1.8651E−03 | 1.4120E−03 |
| R10 | −1.7668E+00 | −3.6313E−02 | 1.4932E−03 | 7.1837E−03 | −5.3525E−03 | 2.2049E−03 | −5.9976E−04 |
| R11 | −9.9285E−01 | −4.1855E−03 | −9.8114E−03 | 5.5017E−03 | −2.0907E−03 | 5.5844E−04 | −1.0615E−04 |
| R12 | 3.0129E−01 | 2.5126E−02 | −1.2479E−02 | 3.4001E−03 | −6.9662E−04 | 1.1209E−04 | −1.4482E−05 |
| R13 | −1.1682E+00 | −4.5545E−02 | 6.9535E−03 | −7.0084E−04 | 5.8671E−05 | −3.5415E−06 | 6.7579E−08 |
| R14 | −1.0092E+00 | −5.8262E−02 | 1.3185E−02 | −2.5922E−03 | 4.0649E−04 | −4.8661E−05 | 4.3512E−06 |

TABLE 12

| | Aspheric Coefficient | | | | | | | |
|---|---|---|---|---|---|---|---|---|
| | A16 | A18 | A20 | A22 | A24 | A26 | A28 | A30 |
| R1 | 5.0794E−05 | −1.9345E−05 | 3.8939E−06 | −4.5227E−07 | 2.8651E−08 | −7.6873E−10 | 0.0000E+00 | 0.0000E+00 |
| R2 | −1.2648E−03 | 3.1754E−04 | −5.2810E−05 | 5.5988E−06 | −3.4300E−07 | 9.2476E−09 | 0.0000E+00 | 0.0000E+00 |
| R3 | −8.6265E−05 | −9.4486E−04 | 4.2289E−04 | −9.6890E−05 | 1.2918E−05 | −9.5318E−07 | 3.0227E−08 | −8.1813E−15 |
| R4 | −5.3070E−02 | 3.0848E−02 | −1.2616E−02 | 3.6011E−03 | −7.0208E−04 | 8.9101E−05 | −6.6351E−06 | 2.2001E−07 |
| R5 | 2.4978E−01 | −1.2109E−01 | 4.2115E−02 | −1.0433E−02 | 1.7967E−03 | −2.0439E−04 | 1.3806E−05 | −4.1918E−07 |
| R6 | 8.1317E−02 | −3.0618E−02 | 8.2988E−03 | −1.6070E−03 | 2.1695E−04 | −1.9405E−05 | 1.0338E−06 | −2.4844E−08 |
| R7 | 2.8798E−02 | −9.3657E−03 | 2.1642E−03 | −3.5129E−04 | 3.8913E−05 | −2.7797E−06 | 1.1429E−07 | −2.0290E−09 |
| R8 | 8.2410E−03 | −2.6703E−03 | 6.3138E−04 | −1.0766E−04 | 1.2878E−05 | −1.0240E−06 | 4.8553E−08 | −1.0377E−09 |
| R9 | −6.1998E−04 | 1.7785E−04 | −3.4839E−05 | 4.7096E−06 | −4.3291E−07 | 2.5850E−08 | −9.0417E−10 | 1.4052E−11 |
| R10 | 1.1236E−04 | −1.4610E−05 | 1.3070E−06 | −7.8319E−08 | 2.9597E−09 | −6.0979E−11 | 3.8283E−13 | 4.5294E−15 |
| R11 | 1.4396E−05 | −1.3961E−06 | 9.6769E−08 | −4.7536E−09 | 1.6163E−10 | −3.6192E−12 | 4.8022E−14 | −2.8616E−16 |
| R12 | 1.4942E−06 | −1.2001E−07 | 7.2777E−09 | −3.2300E−10 | 1.0105E−11 | −2.1023E−13 | 2.6050E−15 | −1.4523E−17 |
| R13 | 9.3155E−09 | −9.4939E−10 | 4.4233E−11 | −1.2180E−12 | 2.0317E−14 | −1.9070E−16 | 7.7597E−19 | 3.4462E−26 |
| R14 | −2.8816E−07 | 1.4075E−08 | −5.0373E−10 | 1.3022E−11 | −2.3637E−13 | 2.8552E−15 | −2.0596E−17 | 6.7085E−20 |

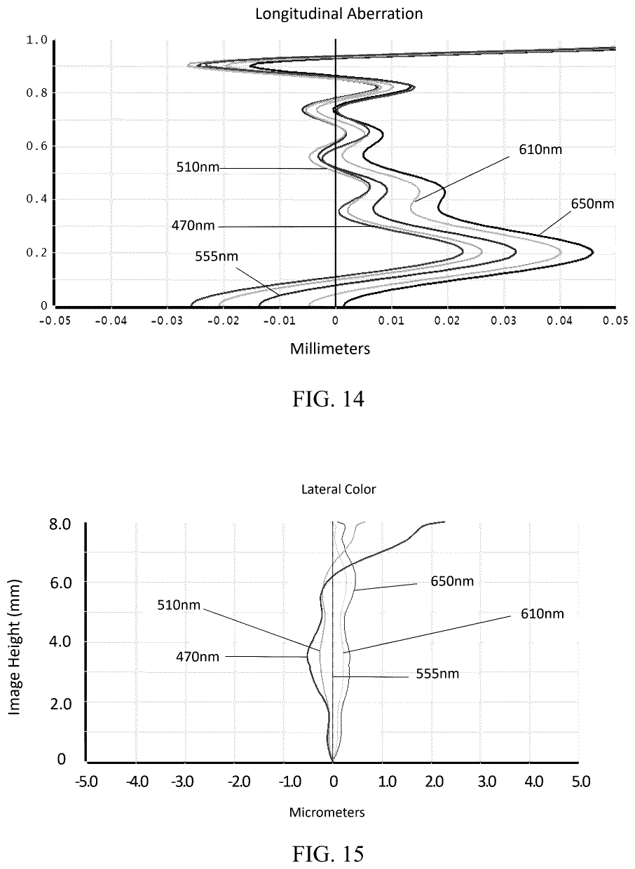

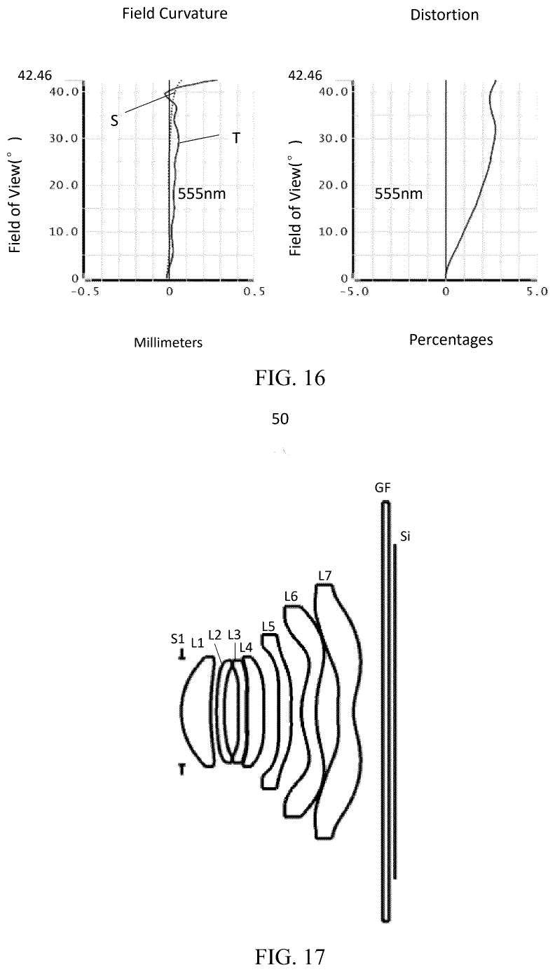

FIG. 14 and FIG. 15 respectively show longitudinal aberration and lateral color of light with wavelengths of 650 nm, 610 nm, 555 nm, 510 nm, and 470 nm after passing through the camera optical lens 40 according to Example 4. FIG. 16 shows field curvature and distortion of light with a wavelength of 555 nm after passing through the camera optical lens 40 according to Example 4, the field curvature S in FIG. 16 is a field curvature in the sagittal direction, and T is a field curvature in the meridian direction.

In this Example, the entrance pupil diameter ENPD of the camera optical lens 40 is 5.146 mm, the image height IH at 1.0 field of view is 8.000 mm, the field of view FOV at 1.0 field of view is 84.91°, the image height IHm at MIC field of view is 8.170 mm, and the field of view FOVm at MIC field of view is 86.15°. The camera optical lens 40 meets the design requirements of large aperture, wide-angle and ultra-thinness, effectively correcting both the on-axis and off-axis chromatic aberrations thereof, and has excellent optical characteristics.

### Example 5

Example 5 is substantially the same as Example 1, the reference signs have the same meaning as Example 1, and only differences are listed below.

FIG. 17 shows a camera optical lens 50 according to Example 5 of the present disclosure.

Table 13 shows design data of the camera optical lens 50 according to Example 5 of the present disclosure.

TABLE 13

| | R | d | | nd | | νd | |
|---|---|---|---|---|---|---|---|
| S1 | INF | d0= | −0.035 | | | | |
| R1 | 3.442 | d1= | 1.385 | nd1 | 1.4959 | ν1 | 81.64 |
| R2 | 10.677 | d2= | 0.290 | | | | |
| R3 | 10.441 | d3= | 0.356 | nd2 | 1.6700 | ν2 | 19.39 |
| R4 | 8.241 | d4= | 0.677 | | | | |
| R5 | 58.873 | d5= | 0.357 | nd3 | 1.6700 | ν3 | 19.39 |
| R6 | 15.578 | d6= | 0.061 | | | | |
| R7 | 20.238 | d7= | 0.790 | nd4 | 1.5444 | ν4 | 55.82 |
| R& | −78.819 | d8= | 0.700 | | | | |
| R9 | 27.197 | d9= | 0.588 | nd5 | 1.5661 | ν5 | 37.71 |
| R10 | 19.240 | d10= | 0.475 | | | | |
| R11 | 3.500 | d11= | 0.707 | nd6 | 1.5444 | ν6 | 55.82 |
| R12 | 8.754 | d12= | 1.019 | | | | |
| R13 | 7.074 | d13= | 0.741 | nd7 | 1.5346 | ν7 | 55.69 |
| R14 | 2.463 | d14= | 1.393 | | | | |
| R15 | INF | d15= | 0.310 | ndg | 1.5168 | νg | 64.17 |
| R16 | INF | d16= | 0.257 | | | | |

Table 14 and Table 15 show aspheric surface data of each lens in the camera optical lens 50 according to Example 5 of the present disclosure.

TABLE 14

| | Conic Coefficient | Aspheric Coefficient | | | | | |
|---|---|---|---|---|---|---|---|
| | k | A4 | A6 | A8 | A10 | A12 | A14 |
| R1 | 9.8704E−03 | −8.0177E−04 | 1.2440E−03 | −1.3850E−03 | 8.8537E−04 | −2.6429E−04 | −2.5310E−05 |
| R2 | 2.9509E+00 | −2.4621E−03 | −1.0343E−03 | −2.1329E−03 | 5.6328E−03 | −5.6976E−03 | 3.3476E−03 |
| R3 | −1.2218E−02 | −8.8040E−03 | 1.5412E−02 | −3.1114E−02 | 3.5087E−02 | −2.2212E−02 | 7.1765E−03 |
| R4 | 9.3334E−02 | −5.0137E−03 | 9.0060E−03 | −2.0779E−02 | 3.8154E−02 | −5.6670E−02 | 6.4552E−02 |
| R5 | 1.8015E+01 | −6.3315E−03 | −2.3527E−02 | 1.0718E−01 | −2.5725E−01 | 3.7637E−01 | −3.6722E−01 |
| R6 | −4.2513E−01 | −3.4415E−03 | −3.3142E−02 | 1.0374E−01 | −1.8475E−01 | 2.0591E−01 | −1.5454E−01 |
| R7 | −3.7575E+00 | −5.2139E−03 | −2.5219E−02 | 6.3812E−02 | −9.7642E−02 | 9.5375E−02 | −6.2765E−02 |
| R8 | −5.8426E+02 | −8.0051E−03 | −1.1696E−02 | 2.5242E−02 | −3.3926E−02 | 3.0036E−02 | −1.8547E−02 |
| R9 | −6.7580E+01 | −1.7970E−02 | 4.4594E−03 | −4.5529E−04 | 9.8244E−04 | −1.8651E−03 | 1.4120E−03 |
| R10 | 2.9680E+00 | −3.6140E−02 | 1.4973E−03 | 7.1837E−03 | −5.3526E−03 | 2.2049E−03 | −5.9976E−04 |
| R11 | −9.4280E−01 | −4.0578E−03 | −9.8145E−03 | 5.5015E−03 | −2.0907E−03 | 5.5844E−04 | −1.0615E−04 |
| R12 | −5.3897E−01 | 2.4862E−02 | −1.2473E−02 | 3.4004E−03 | −6.9662E−04 | 1.1209E−04 | −1.4482E−05 |
| R13 | −1.2124E+00 | −4.5560E−02 | 6.9529E−03 | −7.0086E−04 | 5.8671E−05 | −3.5415E−06 | 6.7579E−08 |
| R14 | −1.0168E+00 | −5.8310E−02 | 1.3184E−02 | −2.5922E−03 | 4.0649E−04 | −4.8661E−05 | 4.3512E−06 |

TABLE 15

| | Aspheric Coefficient | | | | | | | |
|---|---|---|---|---|---|---|---|---|
| | A16 | A18 | A20 | A22 | A24 | A26 | A28 | A30 |
| R1 | 5.0795E−05 | −1.9346E−05 | 3.8939E−06 | −4.5227E−07 | 2.8651E−08 | −7.6870E−10 | 0.0000E+00 | 0.0000E+00 |
| R2 | −1.2648E−03 | 3.1754E−04 | −5.2810E−05 | 5.5988E−06 | −3.4300E−07 | 9.2477E−09 | 0.0000E+00 | 0.0000E+00 |
| R3 | −8.6263E−05 | −9.4486E−04 | 4.2289E−04 | −9.6890E−05 | 1.2918E−05 | −9.5318E−07 | 3.0227E−08 | −1.7802E−14 |
| R4 | −5.3070E−02 | 3.0848E−02 | −1.2616E−02 | 3.6011E−03 | −7.0208E−04 | 8.9101E−05 | −6.6351E−06 | 2.2001E−07 |
| R5 | 2.4978E−01 | −1.2109E−01 | 4.2115E−02 | −1.0433E−02 | 1.7967E−03 | −2.0439E−04 | 1.3806E−05 | −4.1918E−07 |
| R6 | 8.1317E−02 | −3.0618E−02 | 8.2988E−03 | −1.6070E−03 | 2.1695E−04 | −1.9405E−05 | 1.0338E−06 | −2.4844E−08 |
| R7 | 2.8798E−02 | −9.3657E−03 | 2.1642E−03 | −3.5129E−04 | 3.8913E−05 | −2.7797E−06 | 1.1429E−07 | −2.0290E−09 |
| R8 | 8.2410E−03 | −2.6703E−03 | 6.3138E−04 | −1.0766E−04 | 1.2878E−05 | −1.0240E−06 | 4.8553E−08 | −1.0377E−09 |
| R9 | −6.1998E−04 | 1.7785E−04 | −3.4839E−05 | 4.7096E−06 | −4.3291E−07 | 2.5850E−08 | −9.0417E−10 | 1.4052E−11 |
| R10 | 1.1236E−04 | −1.4610E−05 | 1.3070E−06 | −7.8319E−08 | 2.9597E−09 | −6.0979E−11 | 3.8283E−13 | 4.5294E−15 |
| R11 | 1.4396E−05 | −1.3961E−06 | 9.6769E−08 | −4.7536E−09 | 1.6163E−10 | −3.6192E−12 | 4.8022E−14 | −2.8616E−16 |
| R12 | 1.4942E−06 | −1.2001E−07 | 7.2777E−09 | −3.2300E−10 | 1.0105E−11 | −2.1023E−13 | 2.6050E−15 | −1.4523E−17 |
| R13 | 9.3154E−09 | −9.4939E−10 | 4.4233E−11 | −1.2180E−12 | 2.0317E−14 | −1.9070E−16 | 7.7598E−19 | 8.9289E−26 |
| R14 | −2.8816E−07 | 1.4075E−08 | −5.0373E−10 | 1.3022E−11 | −2.3637E−13 | 2.8552E−15 | −2.0596E−17 | 6.7085E−20 |

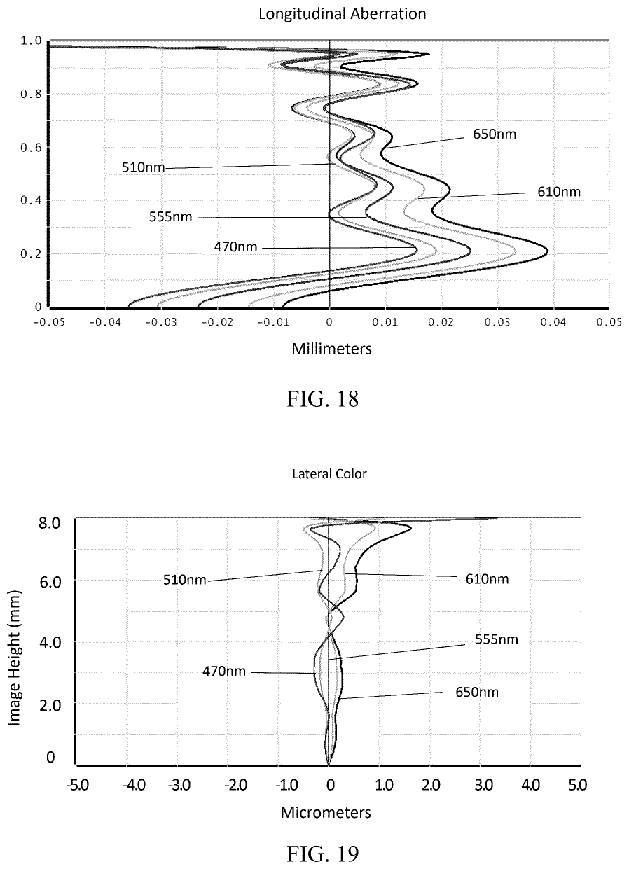

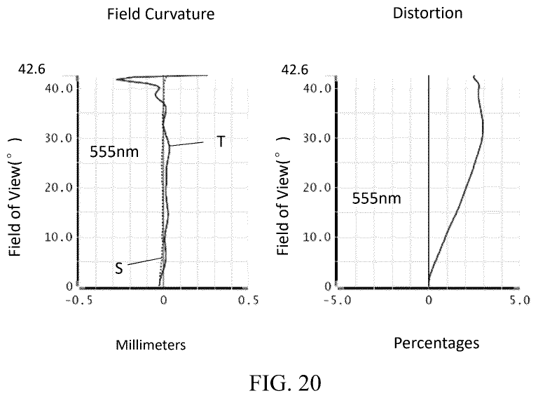

FIG. 18 and FIG. 19 respectively show longitudinal aberration and lateral color of light with wavelengths of 650 nm, 610 nm, 555 nm, 510 nm, and 470 nm after passing through the camera optical lens 50 according to Example 5. FIG. 20 shows field curvature and distortion of light with a wavelength of 555 nm after passing through the camera optical lens 50 according to Example 5, the field curvature S in FIG. 20 is a field curvature in the sagittal direction, and T is a field curvature in the meridian direction.

In this Example, the entrance pupil diameter ENPD of the camera optical lens 50 is 5.114 mm, the image height IH at 1.0 field of view is 8.000 mm, the field of view FOV at 1.0 field of view is 85.28°, the image height IHm at MIC field of view is 8.170 mm, and the field of view FOVm at MIC field of view is 86.52°. The camera optical lens 50 meets the design requirements of large aperture, wide-angle and ultra-thinness, effectively correcting both the on-axis and off-axis chromatic aberrations thereof, and has excellent optical characteristics.

Table 19 shows values of various values in Example 1, Example 2, Example 3, Example 4 and Example 5 corresponding to parameters specified in the relational expressions.

### Comparative Example

The comparative embodiment is substantially the same as Example 1, the reference signs meaning is the same as that of Example 1, and only differences are listed below.

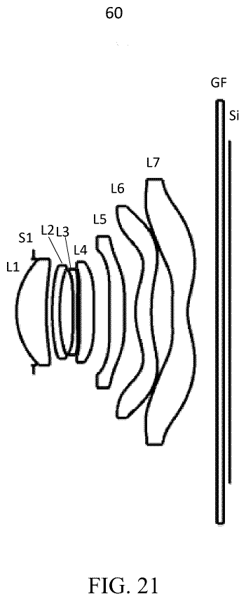

FIG. 21 shows a camera optical lens 60 according to Comparative Example.

Table 16 shows design data of the camera optical lens 60 according to Comparative Example.

TABLE 16

| | R | d | | nd | | νd | |
|---|---|---|---|---|---|---|---|
| S1 | INF | d0= | −0.815 | | | | |
| R1 | 3.469 | d1= | 1.399 | nd1 | 1.4959 | ν1 | 81.64 |
| R2 | 10.773 | d2= | 0.279 | | | | |
| R3 | 8.619 | d3= | 0.349 | nd2 | 1.6700 | ν2 | 19.39 |
| R4 | 7.438 | d4= | 0.615 | | | | |
| R5 | 54.811 | d5= | 0.200 | nd3 | 1.6700 | ν3 | 19.39 |
| R6 | 14.206 | d6= | 0.113 | | | | |
| R7 | 20.946 | d7= | 0.682 | nd4 | 1.5444 | ν4 | 55.82 |
| R8 | −94.067 | d8= | 0.730 | | | | |
| R9 | 28.773 | d9= | 0.700 | nd5 | 1.5661 | ν5 | 37.71 |
| R10 | 19.060 | d10= | 0.516 | | | | |
| R11 | 3.510 | d11= | 0.747 | nd6 | 1.5444 | ν6 | 55.82 |
| R12 | 10.795 | d12= | 0.980 | | | | |
| R13 | 7.922 | d13= | 0.724 | nd7 | 1.5346 | ν7 | 55.69 |
| R14 | 2.494 | d14= | 1.386 | | | | |
| R15 | INF | d15= | 0.310 | ndg | 1.5168 | νg | 64.17 |
| R16 | INF | d16= | 0.287 | | | | |

Table 17 and Table 18 show aspheric surface data of each lens in the camera optical lens 60 as described in Comparative Example of the present disclosure.

TABLE 17

| | Conic Coefficient | Aspheric Coefficient | | | | | |
|---|---|---|---|---|---|---|---|
| | k | A4 | A6 | A8 | A10 | A12 | A14 |
| R1 | 7.0860E−04 | −8.5595E−04 | 1.2550E−03 | −1.3852E−03 | 8.8552E−04 | −2.6430E−04 | −2.5310E−05 |
| R2 | 2.4520E+00 | −2.4638E−03 | −1.0611E−03 | −2.1302E−03 | 5.6331E−03 | −5.6974E−03 | 3.3476E−03 |
| R3 | −1.9598E+00 | −8.8421E−03 | 1.5432E−02 | −3.1117E−02 | 3.5087E−02 | −2.2213E−02 | 7.1765E−03 |
| R4 | 9.7480E−02 | −4.8342E−03 | 8.9969E−03 | −2.0787E−02 | 3.8152E−02 | −5.6670E−02 | 6.4552E−02 |
| R5 | −7.5006E+02 | −6.6842E−03 | −2.3517E−02 | 1.0716E−01 | −2.5725E−01 | 3.7636E−01 | −3.6722E−01 |
| R6 | 1.5003E+00 | −3.2652E−03 | −3.3117E−02 | 1.0375E−01 | −1.8475E−01 | 2.0591E−01 | −1.5454E−01 |
| R7 | 5.6070E+00 | −5.0373E−03 | −2.5158E−02 | 6.3797E−02 | −9.7645E−02 | 9.5375E−02 | −6.2765E−02 |
| R8 | 1.3206E+03 | −8.2798E−03 | −1.1784E−02 | 2.5231E−02 | −3.3925E−02 | 3.0037E−02 | −1.8547E−02 |
| R9 | −5.4881E+01 | −1.7606E−02 | 4.5167E−03 | −4.5226E−04 | 9.8278E−04 | −1.8651E−03 | 1.4120E−03 |
| R10 | −4.2429E+00 | −3.6271E−02 | 1.4953E−03 | 7.1837E−03 | −5.3525E−03 | 2.2049E−03 | −5.9976E−04 |
| R11 | −9.9665E−01 | −4.1709E−03 | −9.8119E−03 | 5.5018E−03 | −2.0907E−03 | 5.5844E−04 | −1.0615E−04 |
| R12 | −2.5004E+00 | 2.5059E−02 | −1.2486E−02 | 3.4001E−03 | −6.9662E−04 | 1.1209E−04 | −1.4482E−05 |
| R13 | −1.1867E+00 | −4.5552E−02 | 6.9533E−03 | −7.0085E−04 | 5.8671E−05 | −3.5415E−06 | 6.7579E−08 |
| R14 | −1.0143E+00 | −5.8255E−02 | 1.3183E−02 | −2.5922E−03 | 4.0649E−04 | −4.8661E−05 | 4.3512E−06 |

TABLE 18

| | Aspheric Coefficient | | | | | | | |
|---|---|---|---|---|---|---|---|---|
| | A16 | A18 | A20 | A22 | A24 | A26 | A28 | A30 |
| R1 | 5.0795E−05 | −1.9345E−05 | 3.8939E−06 | −4.5227E−07 | 2.8652E−08 | −7.6882E−10 | 0.0000E+00 | 0.0000E+00 |
| R2 | −1.2648E−03 | 3.1754E−04 | −5.2810E−05 | 5.5988E−06 | −3.4300E−07 | 9.2473E−09 | 0.0000E+00 | 0.0000E+00 |
| R3 | −8.6271E−05 | −9.4486E−04 | 4.2289E−04 | −9.6890E−05 | 1.2918E−05 | −9.5318E−07 | 3.0227E−08 | 1.3134E−13 |
| R4 | −5.3070E−02 | 3.0848E−02 | −1.2616E−02 | 3.6011E−03 | −7.0208E−04 | 8.9101E−05 | −6.6351E−06 | 2.2001E−07 |
| R5 | 2.4978E−01 | −1.2109E−01 | 4.2115E−02 | −1.0433E−02 | 1.7967E−03 | −2.0439E−04 | 1.3806E−05 | −4.1918E−07 |
| R6 | 8.1317E−02 | −3.0618E−02 | 8.2988E−03 | −1.6070E−03 | 2.1695E−04 | −1.9405E−05 | 1.0338E−06 | −2.4845E−08 |
| R7 | 2.8798E−02 | −9.3657E−03 | 2.1642E−03 | −3.5129E−04 | 3.8913E−05 | −2.7797E−06 | 1.1429E−07 | −2.0298E−09 |
| R8 | 8.2410E−03 | −2.6703E−03 | 6.3138E−04 | −1.0766E−04 | 1.2878E−05 | −1.0240E−06 | 4.8553E−08 | −1.0377E−09 |
| R9 | −6.1998E−04 | 1.7785E−04 | −3.4839E−05 | 4.7096E−06 | −4.3291E−07 | 2.5850E−08 | −9.0417E−10 | 1.4052E−11 |
| R10 | 1.1236E−04 | −1.4610E−05 | 1.3070E−06 | −7.8319E−08 | 2.9597E−09 | −6.0979E−11 | 3.8283E−13 | 4.5293E−15 |
| R11 | 1.4396E−05 | −1.3961E−06 | 9.6770E−08 | −4.7536E−09 | 1.6163E−10 | −3.6192E−12 | 4.8022E−14 | −2.8616E−16 |
| R12 | 1.4942E−06 | −1.2001E−07 | 7.2777E−09 | −3.2300E−10 | 1.0105E−11 | −2.1023E−13 | 2.6050E−15 | −1.4523E−17 |
| R13 | 9.3154E−09 | −9.4939E−10 | 4.4233E−11 | −1.2180E−12 | 2.0317E−14 | −1.9070E−16 | 7.7597E−19 | 8.3426E−26 |
| R14 | −2.8816E−07 | 1.4075E−08 | −5.0373E−10 | 1.3022E−11 | −2.3637E−13 | 2.8552E−15 | −2.0596E−17 | 6.7085E−20 |

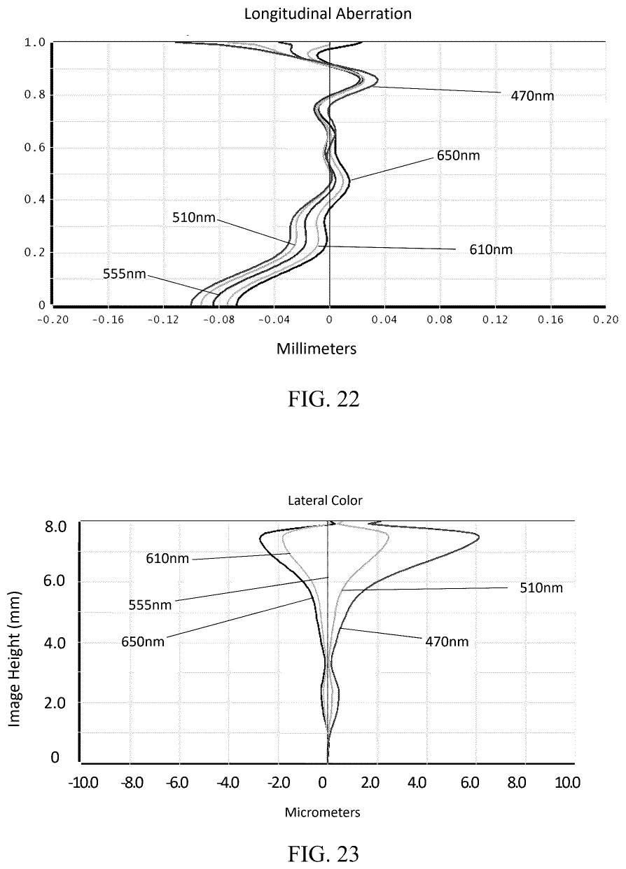

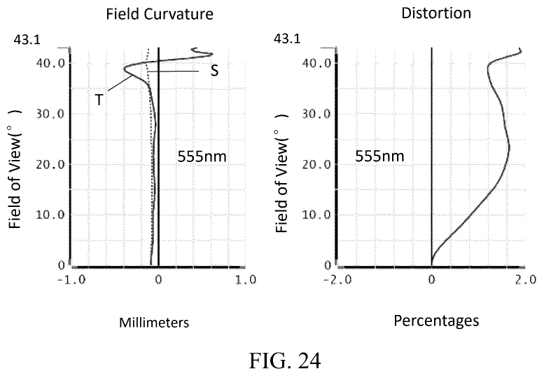

FIG. 22 and FIG. 23 respectively show longitudinal aberration and lateral color of light with wavelengths of 650 nm, 610 nm, 555 nm, 510 nm, and 470 nm after passing through the camera optical lens 60 according to Comparative Example. FIG. 24 shows field curvature and distortion of light with a wavelength of 555 nm after passing through the camera optical lens 60 according to Comparative Example, the field curvature S in FIG. 24 is a field curvature in the sagittal direction, and T is a field curvature in the meridian direction.

Table 19 below lists values corresponding to each relational expression in Comparative Example according to the above relational expressions. The camera optical lens 60 of Comparative Example does not satisfy the above relational expression 17.00≤(f6−f7)/d12≤20.00.

In the Comparative Example, the entrance pupil diameter ENPD of the camera optical lens 60 is 5.013 mm, the image height IH of the 1.0 field of view is 8.000 mm, the field of view FOV of the 1.0 field of view is 86.18°, the image height IHm at MIC field of view is 8.170 mm, and the field of view FOVm at MIC field of view is 87.61°. The camera optical lens 60 does not satisfy the design requirements of the large aperture, wide-angle and ultra-thinness.

TABLE 19

| Parameters and | | | | | | |
|---|---|---|---|---|---|---|
| Relational | | | | | | |
| Expressions | Example 1 | Example 2 | Example 3 | Example 4 | Example 5 | Example 6 |
| R9/R10 | 1.497 | 1.890 | 1.102 | 1.558 | 1.414 | 1.510 |
| (R5 + R6)/(R5 − R6) | 2.029 | 1.504 | 1.691 | 2.799 | 1.720 | 1.700 |
| (f6 − f7)/d12 | 18.310 | 19.954 | 17.090 | 18.088 | 17.322 | 16.646 |
| (v1 − v2)*d2/(f1 − f2) | 0.259 | 0.171 | 0.237 | 0.317 | 0.252 | 0.172 |
| f | 8.474 | 8.548 | 8.321 | 8.490 | 8.438 | 8.271 |
| f1 | 9.681 | 9.644 | 9.779 | 9.633 | 9.607 | 9.678 |
| f2 | −63.963 | −78.938 | −64.209 | −50.635 | −61.895 | −91.078 |
| f3 | −30.680 | −26.322 | −27.128 | −37.404 | −31.431 | −28.415 |
| f4 | 30.901 | 29.024 | 33.303 | 31.310 | 29.567 | 31.432 |
| f5 | −108.969 | −66.914 | −420.991 | −93.037 | −118.782 | −101.915 |
| f6 | 9.327 | 8.875 | 9.043 | 9.416 | 10.194 | 9.189 |
| f7 | −7.427 | −7.440 | −7.400 | −7.318 | −7.465 | −7.117 |
| FNO | 1.650 | 1.650 | 1.650 | 1.650 | 1.650 | 1.650 |
| TTL | 10.150 | 10.193 | 10.140 | 10.144 | 10.106 | 10.017 |
| IH | 8.000 | 8.003 | 8.000 | 8.000 | 8.000 | 8.000 |
| FOV | 84.88 | 84.38 | 85.82 | 84.91 | 85.28 | 86.18 |

The above description just refers to embodiments of the present disclosure. It should be noted that those skilled in the art can also make improvements without departing from the concept of the present disclosure, all of which shall fall within the protection scope of the present disclosure.

What is claimed is:

1. A camera optical lens, comprising seven lenses sequentially from an object side to an image side: a first lens with positive refractive power, a second lens with negative refractive power, a third lens with negative refractive power, a fourth lens with positive refractive power, a fifth lens with negative refractive power, a sixth lens with positive refractive power, and a seventh lens with negative refractive power; a central curvature radius of an object-side surface of the third lens is R5, a central curvature radius of an image-side surface of the third lens is R6, a central curvature radius of an object-side surface of the fifth lens is R9, a central curvature radius of an image-side surface of the fifth lens is R10, a focal length of the first lens is f1, a focal length of the second lens is f2, a focal length of the sixth lens is f6, a focal length of the seventh lens is f7, an on-axis distance from an image-side surface of the first lens to an object-side surface of the second lens is d2, an on-axis distance from an image-side surface of the sixth lens to an object-side surface of the seventh lens is d12, an Abbe number of the first lens is v1, an Abbe number of the second lens is v2, and following relational expressions are satisfied:
$$1.1 \leq R 9 / R 10 \leq 1.9 ;$$
$$1.5 \leq ( R 5 + R 6 ) / ( R 5 - R 6 ) \leq 2.8 ;$$
$$17. \leq ( f 6 - f 7 ) / d 12 \leq 20. ; and$$
$$0.17 \leq {( v 1 - v 2 )}^{*} d 2 / ( f 1 - f 2 ) \leq 0.32 .$$

2. The camera optical lens as described in claim 1, wherein a central curvature radius of an object-side surface of the sixth lens is R11, a central curvature radius of the image-side surface of the sixth lens is R12, the focal length of the sixth lens is f6, and a following relational expression is satisfied:
$$1. 2 \leq ( R 11 + R 12 ) / f 6 \leq 2.05 .$$

3. The camera optical lens as described in claim 1, wherein a focal length of the camera optical lens is f, a combined focal length of the first lens, the second lens, the third lens and the fourth lens is f1234, and a following relational expression is satisfied:
$$1. 25 \leq f 1234 / f \leq 1.4 .$$

4. The camera optical lens as described in claim 1, wherein an object-side surface of the first lens is convex in a paraxial region, and the image-side surface of the first lens is concave in the paraxial region;
a focal length of the camera optical lens is f, the focal length of the first lens is f1, a central curvature radius of the object-side surface of the first lens is R1, a central curvature radius of the image-side surface of the first lens is R2, an on-axis thickness of the first lens is d1, and a total optical length from the object-side surface of the first lens to an image plane of the camera optical lens along an optic axis of the camera optical lens is TTL, and following relational expressions are satisfied:
$$1.12 \leq f 1 / f \leq 1.18 ;$$
$$- 1.97 \leq ( R 1 + R 2 ) / ( R 1 - R 2 ) \leq - 1.93 ; and$$
$$0.13 \leq d 1 / TTL \leq 0.14 .$$

5. The camera optical lens as described in claim 1, wherein the object-side surface of the second lens is convex in a paraxial region, and an image-side surface of the second lens is concave in the paraxial region;
a focal length of the camera optical lens is f, a central curvature radius of the object-side surface of the second lens is R3, a curvature radius of the image-side surface of the second lens is R4, an on-axis thickness of the second lens is d3, a total optical length from an object-side surface of the first lens to an image plane of the camera optical lens along an optic axis of the camera optical lens is TTL, and following relational expressions are satisfied:
$$- 9.24 \leq f 2 / f \leq - 5.96 ;$$
$$7.14 \leq ( R 3 + R 4 ) / ( R 3 - R 4 ) \leq 10.82 ; and$$
$$0.03 \leq d 3 / TTL \leq 0.04 .$$

6. The camera optical lens as described in claim 1, wherein the object-side surface of the third lens is convex in a paraxial region, and the image-side surface of the third lens is concave in the paraxial region, and
a focal length of the camera optical lens is f, a focal length of the third lens is f3, an on-axis thickness of the third lens is d5, a total optical length from an object-side surface of the first lens to an image plane of the camera optical lens along an optic axis of the camera optical lens is TTL, and following relational expressions are satisfied:
$$- 4.41 \leq f 3 / f \leq - 3.07 ; and$$
$$0.03 \leq d 5 / TTL \leq 0.04 .$$

7. The camera optical lens as described in claim 1, wherein an object-side surface of the fourth lens is convex in a paraxial region, and an image-side surface of the fourth lens is convex in the paraxial region, and
a focal length of the camera optical lens is f, a focal length of the fourth lens is f4, a central curvature radius of the object-side surface of the fourth lens is R7, a central curvature radius of the image-side surface of the fourth lens is R8, and following relational expressions are satisfied:
$$3. 39 \leq f 4 / f \leq 4.01 ; and$$
$$- 0.91 \leq ( R 7 + R 8 ) / ( R 7 - R 8 ) \leq - 0.59 .$$

8. The camera optical lens as described in claim 1, wherein the object-side surface of the fifth lens is convex in a paraxial region, and the image-side surface of the fifth lens is concave in the paraxial region;
a focal length of the camera optical lens is f, a focal length of the fifth lens is f5, and following relational expression is satisfied:
$$- 50.60 \leq f 5 / f \leq - 7.82 ; and$$
$$3. 24 \leq ( R 9 + R 10 ) / ( R 9 - R 10 ) \leq 20.56 .$$

9. The camera optical lens as described in claim 1, wherein an object-side surface of the sixth lens is convex in a paraxial region, and the image-side surface of the sixth lens is concave in the paraxial region, and
a focal length of the camera optical lens is f, a central curvature radius of the object-side surface of the sixth lens is R11, a central curvature radius of the image-side surface of the sixth lens is R12, an on-axis thickness of the fifth lens is d11, a total optical length from an object-side surface of the first lens to an image plane of the camera optical lens along an optic axis of the camera optical lens is TTL, and following relational expressions are satisfied:
$$1.03 \leq f 6 / f \leq 1.21 ;$$
$$- 2.34 \leq ( R 11 + R 12 ) / ( R 11 - R 12 ) \leq - 1.68 ; and$$
$$0.06 \leq d 11 / TTL \leq 0.08 .$$

10. The camera optical lens as described in claim 1, wherein the object-side surface of the seventh lens is convex in a paraxial region, and an image-side surface of the seventh lens is concave in the paraxial region; and
a focal length of the camera optical lens is f, a central curvature radius of the object-side surface of the seventh lens is R13, a central curvature radius of the image-side surface of the seventh lens is R14, and following relational expressions are satisfied:
$$- 0.89 \leq f 7 / f \leq - 0.86 ; and$$
$$1.99 \leq ( R 13 + R 14 ) / ( R 13 - R 14 ) \leq 2.07 .$$

11. The camera optical lens as described in claim 1, wherein the first lens is made of glass.
